(19) United States
(12) Patent Application Publication
(10) Pub. No.: US 2023/0249992 A1
(43) Pub. Date: Aug. 10, 2023

(54) METHOD AND APPARATUS FOR REMOVING HYDROGEN PEROXIDE, AND APPARATUS FOR PRODUCING PURE WATER

(71) Applicant: ORGANO CORPORATION, Tokyo (JP)

(72) Inventors: Keisuke SASAKI, Tokyo (JP); Fumio SUDO, Tokyo (JP); Kazushige TAKAHASHI, Tokyo (JP); Tsukasa KONDO, Tokyo (JP); Kenji SHIBASAKI, Tokyo (JP); Mayu ABE, Tokyo (JP)

(73) Assignee: ORGANO CORPORATION, Tokyo (JP)

(21) Appl. No.: 18/011,305

(22) PCT Filed: May 24, 2021
(86) PCT No.: PCT/JP2021/019568

§ 371 Date: Dec. 19, 2022

(30) Foreign Application Priority Data
Jun. 23, 2020 (JP) 2020-107733
Jan. 13, 2021 (JP) 2021-003462
Jan. 13, 2021 (JP) 2021-003463

(51) Int. Cl. C02F 1/42; C02F 1/469; C02F 1/32; C02F 1/58; B01J 31/30

(52) U.S. Cl. CPC C02F 1/42; C02F 1/4695; C02F 1/32; C02F 1/58; B01J 31/30; C02F 2103/04

(57) ABSTRACT

A hydrogen peroxide removing apparatus for removing hydrogen peroxide contained in water to be processed includes: anode and cathode; and hydrogen peroxide removal chamber provided between anode and cathode and at least partially filled with a metal catalyst with hydrogen peroxide decomposition ability, wherein a DC voltage is applied between anode and cathode.

### TECHNICAL FIELD

The present invention relates to a method and an apparatus for removing hydrogen peroxide contained in water in a waste water treatment and a pure water or ultrapure water production process, and a pure water producing apparatus.

### BACKGROUND ART

Conventionally, hydrogen peroxide is widely used as an oxidizing agent together with a chemical solution such as an acid or an alkali in cleaning and surface treatment of electronic components. Since hydrogen peroxide has an oxidizing power, it is necessary to appropriately manage and remove hydrogen peroxide so that hydrogen peroxide does not flow into a device with low oxidation resistance such as an ion exchange resin device constituting a water treatment system. In general, degradation by oxidizing agents causes irreparable fatal damage to water treatment facilities. In particular, it is known that an ion exchange resin in an electrodeionization (EDI) device tends to be deteriorated when an oxidizing agent is present. For example, it is known that, in an ultrapure water production system, a part of the ion exchange resin contained in the ultrapure water production system is oxidatively decomposed to cause elution of an organic substance when hydrogen peroxide is contained in water to be processed.

Since hydrogen peroxide has a high sterilizing power due to having an oxidizing power, it is necessary to remove hydrogen peroxide in advance and then discharge waste water when the waste water containing hydrogen peroxide is discharged from a pure water system to a waste water system outside the system, because hydrogen peroxide may affect biological treatment facilities contained in the waste water treatment system. In addition, in a pure water and ultrapure water production system, an ultraviolet oxidation device for decomposing total organic carbon (TOC) components is sometimes used, and it is known that a minute amount of hydrogen peroxide is contained in the processed water after the ultraviolet oxidation is performed.

Conventionally, as a method of reducing hydrogen peroxide in water to be processed, there are a method of adding a reducing agent, a method of contacting with activated carbon, a method of contacting a resin on which metal is supported, and the like. In the method of adding a reducing agent, a reducing agent such as sodium sulfite, sodium hydrogen sulfite, or sodium thiosulfate is added to the water to be processed which contains hydrogen peroxide. Since the reaction rate of the reducing agent and hydrogen peroxide is very large, it is possible to reliably decompose and remove hydrogen peroxide according to this method, but it is difficult to control the amount of the reducing agent added, and it is also necessary to add an excessive amount of the reducing agent in order to reliably remove hydrogen peroxide, so that the reducing agent increases the amount of ions in the liquid and may cause deterioration in water quality.

In the method of contacting with activated carbon, usually, a packed tower of activated carbon is installed to pass water to be processed, but since the reaction rate is low, there is a problem that the space velocity of passing water cannot be increased and the device becomes large. In addition, there is a concern that the activated carbon itself is also oxidized due to decomposition of hydrogen peroxide, resulting in collapse of particles.

As the method of contacting a resin on which metal is supported, for example, a method has been proposed in which water to be processed which contains hydrogen peroxide is brought into contact with a catalyst resin in which a palladium catalyst or a platinum catalyst is supported on an ion exchange resin [Patent Literature 1]. In this method, hydrogen peroxide is decomposed by the reaction shown in the following formula.

2H₂O₂→2H₂O+O₂

Although not a document relating to decomposition and removal of hydrogen peroxide, Patent Literature 2 discloses that, with regard to an ion exchanger packed in a concentration chamber of an electrodeionization device, the ion exchanger is packed in the concentration chamber so that a volume of the ion exchanger taken out from the concentration chamber after a deionization treatment in a deionization chamber becomes 103% to 125% of a volume of the concentration chamber.

### CITATION LIST

### Patent Literature

Patent Literature 1: JP 2007-185587 A
Patent Literature 2: JP 2016-129863 A

### SUMMARY OF THE INVENTION

### Problem to be Solved by the Invention

Although the method of decomposing and removing hydrogen peroxide by a catalyst resin in which a catalyst made of palladium, platinum or the like is supported on an ion exchange resin has a larger decomposition rate of hydrogen peroxide than the method of contacting with activated carbon, it is desired to further improve the decomposition rate. In addition, in the method using a catalyst resin, it is known that the decomposition rate of hydrogen peroxide decreases with time, and it is desired that hydrogen peroxide can be stably decomposed over a long period of time.

It is an object of the present invention to provide a hydrogen peroxide removing method and an apparatus capable of rapidly and stably treating hydrogen peroxide in a wide concentration region in water to be processed for a long period of time, and a pure water producing apparatus equipped with the hydrogen peroxide removing apparatus. It is another object of the present invention to provide a method and an apparatus for removing hydrogen peroxide which can also be applied to waste water treatment.

### Solution to Problem

The method for removing hydrogen peroxide according to the present invention is a method for removing hydrogen peroxide contained in water to be processed, comprising the step of passing the water to be processed through a hydrogen peroxide removal chamber which is provided between an anode and a cathode and in which a metal catalyst with hydrogen peroxide decomposition ability is at least partially filled, while applying a DC voltage between the anode and the cathode.

The hydrogen peroxide removing apparatus according to the present invention is a hydrogen peroxide removing apparatus for removing hydrogen peroxide contained in water to be processed, comprising: an anode and a cathode; and a hydrogen peroxide removal chamber provided between the anode and the cathode and at least partially filled with a metal catalyst with hydrogen peroxide decomposition ability, wherein a DC voltage is applied between the anode and the cathode.

The pure water producing apparatus according to the present invention is a pure water producing apparatus comprising: the hydrogen peroxide removing apparatus according to the present invention; and an ultraviolet oxidation device provided at a preceding stage of the hydrogen peroxide removing apparatus.

According to the present invention, while passing water to be processed through a hydrogen peroxide removal chamber in which a metal catalyst with hydrogen peroxide decomposition ability is at least partially filled, a DC (direct-current) voltage is applied between the anode and the cathode, so that removal of the reaction product by contact of hydrogen peroxide with the metal catalyst is quickly performed, and the decomposition and removal performance of hydrogen peroxide can be stably maintained high over a long period of time. In particular, in the present invention, it is preferable that an ion exchanger is filled in the hydrogen peroxide removal chamber so that the metal catalyst is supported on at least a part of the ion exchanger. By supporting the metal catalyst on an ion exchanger, when a DC voltage is applied between the anode and the cathode while passing the water to be processed through the hydrogen peroxide removal chamber, decomposition of hydrogen peroxide and electric regeneration of the ion exchanger proceed in parallel, and the decomposition and removal performance of hydrogen peroxide can be stably maintained higher over a long period of time.

Examples of the metal catalyst with hydrogen peroxide decomposition ability in the present invention include, for example, iron, manganese, nickel, gold, silver, copper, chromium, aluminum, and compounds thereof in addition to platinum group metal catalysts such as palladium and platinum. Among them, the platinum group metal catalyst is more suitably used because of its high catalytic activity for hydrogen peroxide decomposition. The platinum group metal catalyst is a catalyst containing one or more metals selected from ruthenium, rhodium, palladium, osmium, iridium and platinum. The platinum group metal catalyst may be one containing any one of these metal elements alone or a combination of two or more of them. Among these, platinum, palladium, and platinum-palladium alloys have high catalytic activity and are suitably used as the platinum group metal catalysts.

The present invention can exhibit more superiority by using an anion exchanger on which a platinum group metal catalyst is supported as the metal catalyst when hydrogen peroxide is removed from water to be processed which contains a carbonic acid component which serves as a load on the anion exchanger. Then, when the hydrogen peroxide removal chamber is compartmentalized by an anion exchange membrane on the anode side thereof, the anion component, i.e., the carbonic acid component, adsorbed to the anion exchanger in the hydrogen peroxide removal chamber from the water to be processed is desorbed from the anion exchanger by electric regeneration and is then discharged in a form of anion from the hydrogen peroxide removal chamber via the anion exchange membrane on the anode side. In other words, according to the present invention, not only the processed water from which hydrogen peroxide has been removed is generated but also the water quality of the processed water can be improved.

In addition, in the present invention, since the regeneration state of the ion exchanger on which the platinum group metal catalyst is supported can be maintained by continuously applying the DC voltage, it is also possible to operate by setting a space velocity (SV) to be equal to or higher than 100 h⁻¹. The space velocity SV is a unit representing how many times the volume of the water to be processed is treated per unit time corresponding to the volume of the ion exchanger which is filled in the hydrogen peroxide removal chamber and on which the platinum group metal catalyst is supported. Specifically, the SV value can be determined by dividing the flow rate (L/h) of the water to be processed by the volume (L) of the ion exchanger on which the platinum group metal catalyst is supported. Enabling the operation at two times and three times the normal SV value is advantageous because it allows the amount of catalyst, which supports noble metal and is expensive, to be reduced by one-half or one-third in order to perform the treatment of the same amount of the water to be processed.

In the hydrogen peroxide removing apparatus according to the present invention, a deionization chamber in which an ion exchanger is filled may be provided adjacent to the hydrogen peroxide removal chamber at the cathode side or the anode side of the hydrogen peroxide removal chamber via an intermediate ion exchange membrane, and the processed water treated in the hydrogen peroxide removal chamber may be passed through the deionization chamber. With this configuration, it is possible to simultaneously perform the removal of hydrogen peroxide from the water to be processed and the deionization of the water to be processed. By using the processed water discharged from the deionization chamber, it becomes possible to produce high-purity pure water and ultrapure water.

In the present invention, it is preferable that a first cation exchange membrane and a first anion exchange membrane which are superposed on each other are arranged between the hydrogen peroxide removal chamber and the cathode so that the first cation exchange membrane is on the side facing the cathode and the first anion exchange membrane is on the side facing the hydrogen peroxide removal chamber. In this configuration, when a DC voltage is applied between the anode and the cathode, a dissociation reaction of water proceeds at an interface between the first cation exchange membrane and the first anion exchange membrane, and hydroxide ions (OH⁻) are supplied from the first anion exchange membrane to the hydrogen peroxide removal chamber. As a result, the electric resistance between the anode and the cathode becomes small, so that a large current can be flowed through the hydrogen peroxide removal chamber at a low voltage, and regeneration of the ion exchanger in the hydrogen peroxide removal chamber can be promoted. When the first cation exchange membrane and the first anion exchange membrane are superposed, they may be simply superposed on each other, or may be configured as a bipolar membrane by arranging a catalyst which promotes the dissociation reaction of water at the interface between them.

Further in the present invention, it is preferable that a packing ratio which is a value obtained by dividing, by a volume of the hydrogen peroxide removal chamber, a volume in a free state of the ion exchanger taken out from the hydrogen peroxide removal chamber after applying a DC voltage between the anode and the cathode and passing the water to be processed through the hydrogen peroxide removal chamber is 95% or more and 125% or less. By filling the ion exchanger into the hydrogen peroxide removal chamber so as to have such a packing ratio, it is possible to further reduce the effective electric resistance of the hydrogen peroxide removal chamber while smoothly passing the water to be processed into the hydrogen peroxide removal chamber, and it is possible to further reduce the value of the DC voltage applied to the hydrogen peroxide removing apparatus. Therefore, by setting the packing ratio of the ion exchanger within the above range, it is possible to reduce the applied DC voltage and to reduce the power consumption per water to be processed of a unit flow rate supplied to the hydrogen peroxide removal chamber.

The above-described packing ratio of the ion exchanger to be filled in the hydrogen peroxide removal chamber is measured after applying a DC voltage between the anode and the cathode to pass the water to be processed through the hydrogen peroxide removal chamber. In this state, the ion exchanger contains sufficient water and is in a state in which the regenerated form and the salt form are mixed with respect to the ionic form. For example, the volume of the ion exchanger which is an ion exchange resin varies depending on the water content and whether the ion form is a regenerated form or a salt form. The volume of the ion exchanger becomes maximum when the ion exchanger sufficiently contains water to swell and the ion form is a regenerated form. Therefore, by filling the hydrogen peroxide removal chamber with an ion exchanger having a relatively small water content and/or an ion exchanger in a salt form with regard to its ionic form, and then applying a DC voltage and passing of water to be processed so as to increase the volume of the ion exchange volume, it is possible to fill the hydrogen peroxide removal chamber with the ion exchanger so that the packing ratio exceeds 100%.

### Advantageous Effects of Invention

According to the present invention, hydrogen peroxide can be stably removed from water to be processed, which contains hydrogen peroxide in a wide concentration range, over a long period of time. As a result, for example, it becomes possible to perform stable operation of the entire water treatment facility to which water to be processed which contains hydrogen peroxide is supplied.

### BRIEF DESCRIPTION OF DRAWINGS

FIG. 1 is a schematic view showing a hydrogen peroxide removing apparatus according to the first embodiment of the present invention;

FIG. 2 is a schematic view showing a specific example of the hydrogen peroxide removing apparatus;

FIG. 3 is a schematic view showing an example of a flow of water in the hydrogen peroxide removing apparatus shown in FIG. 2;

FIG. 4 is a schematic view illustrating another specific example of the hydrogen peroxide removing apparatus;

FIG. 5 is a schematic view illustrating another specific example of the hydrogen peroxide removing apparatus;

FIG. 6 is a schematic view illustrating another specific example of the hydrogen peroxide removing apparatus;

FIG. 7 is a schematic view illustrating another specific example of the hydrogen peroxide removing apparatus;

FIG. 8 is a schematic view illustrating another specific example of the hydrogen peroxide removing apparatus;

FIG. 9 is a schematic view showing a hydrogen peroxide removing apparatus according to the second embodiment of the present invention;

FIG. 10 is a schematic view illustrating another specific example of the hydrogen peroxide removing apparatus;

FIG. 11 is a schematic view illustrating another specific example of the hydrogen peroxide removing apparatus;

FIG. 12 is a schematic view illustrating another specific example of the hydrogen peroxide removing apparatus;

FIG. 13 is a schematic view illustrating another specific example of the hydrogen peroxide removing apparatus;

FIG. 14 is a schematic view showing a hydrogen peroxide removing apparatus according to the third embodiment of the present invention;

FIG. 15 is a schematic view illustrating another specific example of the hydrogen peroxide removing apparatus;

FIG. 16 is a schematic view illustrating the operation of the hydrogen peroxide removing apparatus shown in FIG. 15;

FIG. 17 is a schematic view illustrating another specific example of the hydrogen peroxide removing apparatus;

FIG. 18 is a schematic view illustrating another specific example of the hydrogen peroxide removing apparatus;

FIG. 19 is a schematic view illustrating the operation of the hydrogen peroxide removing apparatus shown in FIG. 18;

FIG. 20 is a schematic view illustrating another specific example of the hydrogen peroxide removing apparatus;

FIG. 21 is a schematic view illustrating the operation of the hydrogen peroxide removing apparatus shown in FIG. 20;

FIG. 22 is a schematic view illustrating another specific example of the hydrogen peroxide removing apparatus;

FIG. 23 is a schematic view illustrating the operation of the hydrogen peroxide removing apparatus shown in FIG. 22;

FIG. 24 is a schematic view illustrating another specific example of the hydrogen peroxide removing apparatus;

FIG. 25 is a schematic view showing a hydrogen peroxide removing apparatus according to the fourth embodiment of the present invention;

FIG. 26 is a schematic view illustrating another specific example of the hydrogen peroxide removing apparatus;

FIG. 27 is a schematic view illustrating another specific example of the hydrogen peroxide removing apparatus;

FIG. 28 is a schematic view illustrating the operation of the hydrogen peroxide removing apparatus shown in FIG. 27;

FIG. 29 is a schematic view illustrating another specific example of the hydrogen peroxide removing apparatus;

FIG. 30 is a schematic view illustrating the operation of the hydrogen peroxide removing apparatus shown in FIG. 29;

FIG. 31 is a schematic view illustrating another specific example of the hydrogen peroxide removing apparatus;

FIG. 32 is a schematic view showing an example of a configuration of a pure water producing apparatus of the prior art;

FIG. 33 is a schematic view showing an example of a configuration of a pure water producing apparatus according to the present invention;

FIG. 34 is a schematic view showing an example of a configuration of an ultrapure water producing apparatus;

FIG. 35 is a schematic view showing another example of a configuration of an ultrapure water producing apparatus;

FIG. 36 is a schematic view showing another example of a configuration of an ultrapure water producing apparatus;

FIG. 37 is a schematic view showing another example of a configuration of an ultrapure water producing apparatus;

FIG. 38 is a schematic view showing a schematic of the apparatus used in Comparative Example 1-1;

FIG. 39 is a schematic view showing a schematic of the device used in Comparative Example 1-2;

FIG. 40 is a schematic view showing a schematic of the apparatus used in Comparative Example 1-3;

FIG. 41 is a schematic view showing an essential portion of the hydrogen peroxide removing apparatus of Example 3;

FIG. 42 is a schematic view showing an essential portion of the hydrogen peroxide removing apparatus of Example 3; and

FIG. 43 is a graph showing the results of Example 6.

### MODES FOR CARRYING OUT THE INVENTION

Next, embodiments of the present invention will be described with reference to the accompanying drawings. However, the present invention is not limited to the embodiments described in the drawings.

### First Embodiment

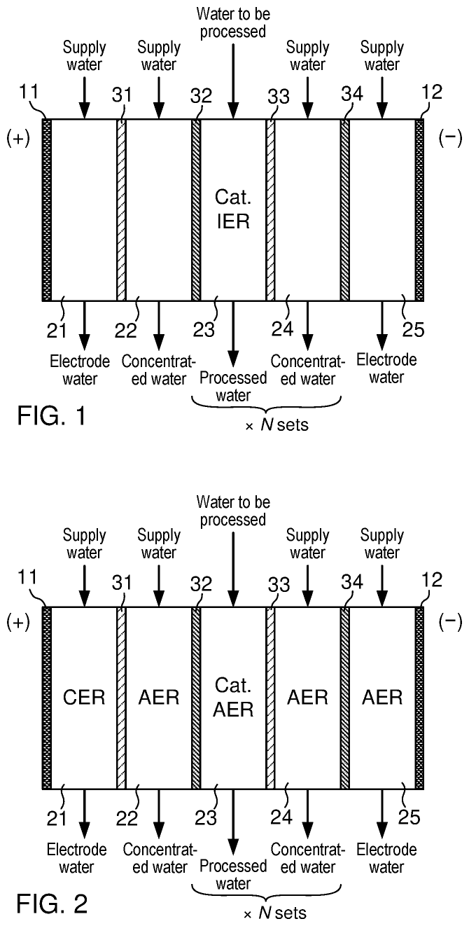

FIG. 1 shows the configuration of the hydrogen peroxide removing apparatus according to the first embodiment of the present invention. The hydrogen peroxide removing apparatus based on the present invention includes at least one hydrogen peroxide removal chamber 23 between anode chamber 21 provided with anode 11 and cathode chamber 25 provided with cathode 12. Hydrogen peroxide removal chamber 23 is partitioned by a first ion exchange membrane located on the side facing anode 11 and a second ion exchange membrane located on the side facing cathode 12. Hydrogen peroxide removal chamber 23 is filled with an ion exchanger on at least a part of which a metal catalyst having hydrogen peroxide decomposition ability is supported. In the example shown in FIG. 1, the first ion exchange membrane disposed on the side of anode 11 is anion exchange membrane 32, and second ion exchange membrane disposed on the side of cathode 12 is cation exchange membrane 33. Inside hydrogen peroxide removal chamber 23, packed is an ion exchanger (IER) on which a platinum group metal catalyst is supported. In the figures, an ion exchanger on which the platinum group metal catalyst is supported is represented by “Cat. IER.” Specifically, in the hydrogen peroxide removing apparatus shown in FIG. 1, anode 11 and cathode 12 are facing each other, and anode chamber 21, first concentration chamber 22, hydrogen peroxide removal chamber 23, second concentration chamber 24 and cathode chamber 25 are disposed between anode 11 and cathode 12 in this order from the side of anode 11. Anode chamber 21 and first concentration chamber 22 are partitioned by cation exchange membrane 31; first concentration chamber 22 and hydrogen peroxide removal chamber 23 are partitioned by anion exchange membrane 32; hydrogen peroxide removal chamber 23 and second concentration chamber 24 are partitioned by cation exchange membrane 33; and second concentration chamber 24 and cathode chamber 25 are partitioned by anion exchange membrane 34. Each of anode chamber 21, first concentration chamber 22, second concentration chamber 24 and cathode chamber 25 are filled with an ion exchanger that does not support a platinum group metal catalyst. Here, as the ion exchanger, any of an anion exchanger and a cation exchanger, or both of them is used. When both of the anion exchanger and the cation exchanger are used, the packing form of the ion exchangers may be a mixed bed configuration in which an anion exchanger and a cation exchanger are mixed and filled, or multilayered bed configuration in which a layer of an anion exchanger and a layer of a cation exchanger are filled so that these layers are formed, respectively.

Next, the operation of the hydrogen peroxide removing apparatus shown in FIG. 1 will be described. When hydrogen peroxide is removed from water to be processed which contains hydrogen peroxide, supply water is passed through each of anode chamber 21, first concentration chamber 22, second concentration chamber 24 and cathode chamber 25, and the water to be processed is passed through hydrogen peroxide removal chamber 23 in a state in which a DC voltage is applied between anode 11 and cathode 12. When the water to be processed containing hydrogen peroxide is passed through hydrogen peroxide removal chamber 23, hydrogen peroxide in the water to be processed is decomposed into water and oxygen by a catalytic reaction with the platinum group metal catalyst supported on the ion exchanger in hydrogen peroxide removal chamber 23. As a result, the processed water from which hydrogen peroxide is removed flows out from hydrogen peroxide removal chamber 23. At this time, in hydrogen peroxide removal chamber 23, a dissociation reaction of water (H₂O→H⁺+OH⁻) occurs simultaneously due to a potential difference generated by the applied current at an interface between different kinds of ion exchangeable substances, and hydrogen ions (H⁺) and hydroxide ions (OH⁻) are generated. The interface of the different kinds of ion exchangeable materials is, for example, an interface between an anion exchange membrane and a cation exchanger, an interface between a cation exchange membrane and an anion exchanger, or an interface between a cation exchanger and an anion exchanger. By the hydrogen ions and the hydroxide ions thus generated, the ionic components previously adsorbed on the ion exchanger in hydrogen peroxide removal chamber 23 are ion-exchanged and desorbed from the ion exchanger. Of the desorbed ionic components, anions move through anion exchange membrane 32 to first concentration chamber 22 closer to anode 11, and are then discharged as concentrated water from first concentration chamber 22. On the other hand, cations move through cation exchange membrane 33 to second concentration chamber 24 closer to cathode 12, and are discharged as concentrated water from this second concentration chamber 24. Eventually, the ionic components in the water to be processed supplied to hydrogen peroxide removal chamber 23 transfer to first concentration chamber 22 and second concentration chamber 24 and are then discharged, and at the same time, the ion exchanger in hydrogen peroxide removal chamber 23 is also regenerated. Incidentally, the electrode water is discharged from each of anode chamber 21 and cathode chamber 25. The application of the DC voltage may be continuously performed at the time of passing the water to be processed, or may be performed intermittently.

There is no particular limitation on the supply water to be passed through concentration chambers 22, 24 and the electrode chambers (i.e., anode chamber 21 and cathode chamber 25), and each of the independent supply water may be used, and the same supply water may be branched and used. Further, the water to be processed or the processed water discharged from hydrogen peroxide removal chamber 23 may be fed as supply water, or the supply water of another system containing no hydrogen peroxide may be fed. In addition, although the flows of the supply water and the water to be processed in the electrode chambers, concentration chambers 22, 24 and hydrogen peroxide removal chamber 23 have mutually co-current relationship in the drawing, but water may be flowed so as to be countercurrent between adjacent chambers.

In the configuration shown in FIG. 1, a basic configuration comprising [concentration chamber (C) 22| anion exchange membrane (AEM) 32|hydrogen peroxide removal chamber (H) 23| cation exchange membrane (CEM) 33|concentration chamber (C) 24] is disposed between anode 11 and cathode 12. This basic configuration is called a cell set. In practice, a plurality of such a cell set (“N set” in FIG. 1) may be juxtaposed between the electrodes so that a plurality of cell sets are electrically connected in series in which one end serves as anode 11 and the other end serves as cathode 12, so as to increase the processing capacity. In this case, since the adjacent concentration chambers can be shared between adjacent cell sets, as a configuration of the hydrogen peroxide removing apparatus according to the present invention, it is possible to have a configuration of [anode chamber |CEM|C|X|X| . . . |X|AEM| cathode chamber] when a repeating unit composed of [AEM|H|CEM|C] is represented by X. In such a series structure, with respect to hydrogen peroxide removal chamber 23 closest to anode chamber 21, anode chamber 21 itself can function as concentration chamber 22 without independently interposing concentration chamber 22 between hydrogen peroxide removal chamber 23 and anode chamber 21. Similarly, with respect to hydrogen peroxide removal chamber 23 closest to cathode chamber 25, cathode chamber 25 itself can function as concentration chamber 24 without independently interposing concentration chamber 24 between hydrogen peroxide removal chamber 23 and cathode chamber 25.

In the hydrogen peroxide removing apparatus according to the present invention, as described above, a DC voltage is applied between anode 11 and cathode 12 to perform removal of hydrogen peroxide and deionization while electrically regenerating an ion exchanger, e.g., a granular ion exchange resin, in hydrogen peroxide removal chamber 23. In order to reduce the voltage applied between anode 11 and cathode 12, it is effective that the ion exchanger is densely filled in hydrogen peroxide removal chamber 23 within a range in which water permeation is not suppressed. In addition, it is known that ion exchangers, particularly ion exchange resins, vary in particle size depending on their water content and ionic form. When the ionic form is in a regenerated form, that is, in a state in which a hydroxide ion is adsorbed to the ion exchange group in case of a anion exchanger and a hydrogen ion is adsorbed to the ion exchange group in case of a cation exchanger, the particle diameter becomes larger than when the ionic form is other than the regenerated form (e.g., a state in which chloride ions or sodium ions are adsorbed), that is, when the ion exchange group is in a salt form. When the water content of the ion exchanger is large, the particle size becomes large. The ion exchanger, particularly the ion exchange resin, has elasticity, deforms when pressure is applied, and has a property of returning to its original shape when the application of pressure is terminated. Therefore, assuming that there is no deformation of hydrogen peroxide removal chamber 23, it is preferable that the ion exchanger is filled in hydrogen peroxide removal chamber 23 in a condition in which the particle diameter is small, and then the ion exchanger is expanded by passing water or electric regeneration so that the ion exchanger is densely filled in hydrogen peroxide removal chamber 23. However, if the ion exchanger is too densely present in hydrogen peroxide removal chamber 23, water passage into hydrogen peroxide removal chamber 23 is inhibited, which is not preferable.

Therefore, in the hydrogen peroxide removing apparatus, it is preferable that a packing ratio, which is a value obtained by dividing, by a volume of hydrogen peroxide removal chamber 23, a volume in a free state of an ion exchanger taken out from hydrogen peroxide removal chamber 23 after applying a DC voltage between anode 11 and cathode 12 to pass the water to be processed through hydrogen peroxide removal chamber 23 is 95% or more and 125% or less. The packing ratio is more preferably 102% or more and 125% or less. Here, the volume of the ion exchanger in the free state is an apparent volume including a void between particles in a state in which the ion exchanger is not restrained by hydrogen peroxide removal chamber 23. As described below, in the hydrogen peroxide removing apparatus according to the present invention, in addition to an ion exchanger on which a metal catalyst is supported, an ion exchanger on which a metal catalyst is not supported may be filled in hydrogen peroxide removal chamber 23 in some cases. Since the effect obtained by setting the packing ratio to 95% or more and 125% or less is considered to be caused by a physical degree of adhesion between the ion exchangers, the packing ratio in a case where the ion exchanger on which the metal catalyst is supported and the ion exchanger on which the metal catalyst is not supported coexist is determined based on the entire volume in the free state of the ion exchangers taken out from hydrogen peroxide removal chamber 23. Hereinafter, various hydrogen peroxide removing apparatuses based on the present invention will be described, but in any of them, the packing ratio of the ion exchanger in hydrogen peroxide removal chamber 23 is preferably set to 95% or more and 125% or less.

FIG. 2 shows an example in which, in the configuration shown in FIG. 1, a cation exchange resin (CER) is filled in anode chamber 21, an anion exchange resin (AER) is filled in concentration chambers 22, 24 and cathode chamber 25, and an anion exchange resin on which the platinum group metal catalyst is supported (Cat. AER) is filled in hydrogen peroxide removal chamber 23.

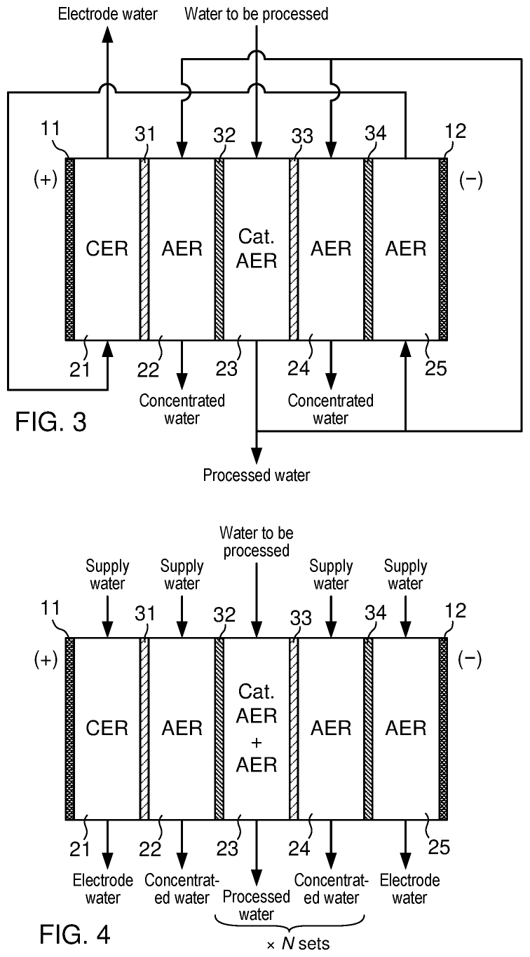

FIG. 3 shows an example in which, in the hydrogen peroxide removing apparatus shown in FIG. 2, as processed water after hydrogen peroxide is removed in hydrogen peroxide removal chamber 23 is used as the supply water for each of anode chamber 21, first concentration chamber 22, second concentration chamber 24 and cathode chamber 25. Portions of the processed water obtained from hydrogen peroxide removal chamber 23 are passed through first concentration chamber 22 and second concentration chamber 24, and are discharged as concentrated water, respectively. Further, a portion of the processed water is passed through cathode chamber 25, and the discharged electrode water is further passed through anode chamber 21. It is more preferable to use the processed water from which hydrogen peroxide has been removed as the supply water to be passed through the concentration chambers and the electrode chambers because it reduces the fear of oxidation and deterioration of the ion exchanger contained in the concentration chambers and the electrode chambers.

In the hydrogen peroxide removing apparatus of the first embodiment, an ion exchanger on which a metal catalyst is not supported can be filled in hydrogen peroxide removal chamber 23, in addition to an anion exchanger on which the platinum group metal catalyst is supported (Cat. AER). Hereinafter, such examples will be described with reference to FIGS. 4 to 7. Any of the hydrogen peroxide removing apparatuses shown in FIGS. 4 to 7 is an apparatus obtained by changing the form of packing the ion exchange resin into hydrogen peroxide removal chamber 23 in the hydrogen peroxide removing apparatus shown in FIG. 2. When an ion exchanger not supporting a metal catalyst is filled in hydrogen peroxide removal chamber 23, it is preferable to define the layout of each ion exchanger so that the ion exchanger supporting the metal catalyst is disposed in contact with the inlet of the water to be processed in hydrogen peroxide removal chamber 23 so that the ion exchanger which does not supporting a metal catalyst is not deteriorated by hydrogen peroxide. In the following explanation, an anion exchange resin on which a platinum group metal catalyst is supported is also referred to as a catalyst-supported anion exchange resin (Cat. AER). When simply referred to as an anion exchange resin (AER) and a cation exchange resin (CER), they refer to an anion exchange resin on which a metal catalyst is not supported and a cation exchange resin on which a metal catalyst is not supported, respectively.

In the hydrogen peroxide removing apparatus shown in FIG. 4, hydrogen peroxide removal chamber 23 is filled with the catalyst-supported anion exchange resin (Cat. AER) and the anion exchange resin (AER) in a manner in which these ion exchange resins are mixed. Note that, a cation exchange resin (CER) may be mixed with the catalyst-supported anion exchange resin (Cat. AER) in place of the anion exchange resin (AER) and then filled. In this configuration, as compared with a case where only the catalyst-supported anion exchange resin (Cat. AER) is filled in hydrogen peroxide removal chamber 23, the amount of the expensive platinum group metal catalyst to be used can be reduced, so that the cost can be reduced.

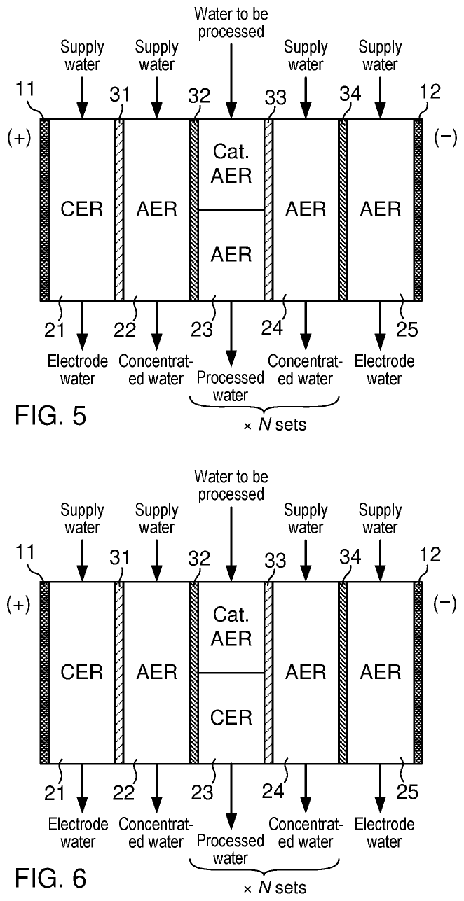

In the hydrogen peroxide removing apparatus shown in FIG. 5, the layer of the catalyst-supported anion exchange resin (Cat. AER) and the layer of the anion exchange resin (AER) are filled in hydrogen peroxide removal chamber 23 in a multilayered bed configuration in which these layers are alternately arranged so that the layer of the catalyst-supported anion exchange resin (Cat. AER) becomes an upstream side along the flow of water. In this hydrogen peroxide removing apparatus, decomposition and removal of hydrogen peroxide is performed in the vicinity of the inlet of the water to be processed in hydrogen peroxide removal chamber 23, and deionization treatment for anions is performed in entire hydrogen peroxide removal chamber 23.

The hydrogen peroxide removing apparatus shown in FIG. 6 is an apparatus obtained by filling a cation exchange resin (CER) instead of the anion exchange resin (AER) in hydrogen peroxide removal chamber 23 of the hydrogen peroxide removing apparatus shown in FIG. 5. Therefore, in hydrogen peroxide removal chamber 23, the layer of the catalyst-supported anion exchange resin (Cat. AER) and the layer of the cation exchange resin (CER) are filled in a multilayered bed configuration so that the layer of the catalyst-supported anion exchange resin (Cat. AER) becomes an upstream side along the flow of water. In this hydrogen peroxide removing apparatus, decomposition and removal of hydrogen peroxide is performed in the vicinity of the inlet of the water to be processed in hydrogen peroxide removal chamber 23, and as a whole, deionization treatment for anions and cations is performed.

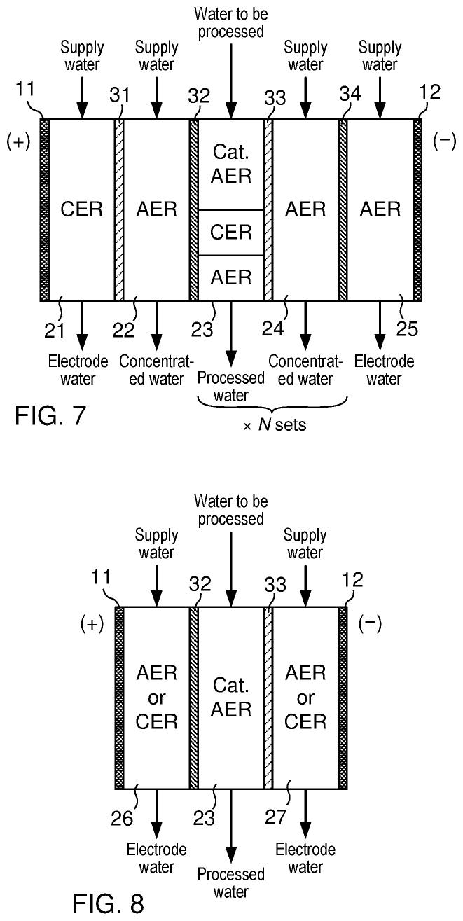

In the hydrogen peroxide removing apparatus shown in FIG. 7, a layer of the catalyst-supported anion exchange resin (Cat. AER), a layer of the cation exchange resin (CER) and a layer of the anion exchange resin (AER) are filled in this order from the upstream side along the flow of water in a multilayered bed configuration in hydrogen peroxide removal chamber 23. Also in hydrogen peroxide removal chamber 23 of this hydrogen peroxide removing apparatus, removal of hydrogen peroxide and deionization treatment for both anions and cations are performed, and regeneration of the respective ion exchange resins is simultaneously performed.

Also in the hydrogen peroxide removing apparatuses described using FIGS. 5 to 7, since hydrogen peroxide removal chamber 23 has a multilayered bed configuration, the amount of the expensive platinum group metal catalyst to be used can be reduced as compared with the case where only the catalyst-supported anion exchange resin (Cat. AER) is filled in hydrogen peroxide removal chamber 23, the cost can be reduced.

As described above, the anode chamber can also function as a concentration chamber without providing a concentration chamber adjacent to the anode chamber, and similarly, the cathode chamber can also function as a concentration chamber without providing a concentration chamber adjacent to the cathode chamber. In the hydrogen peroxide removing apparatus shown in FIG. 8, anode 11, anode chamber 26, anion exchange membrane 32, hydrogen peroxide removal chamber 23, cation exchange membrane 33, cathode chamber 27, and cathode 12 are arranged in this order. Each of anode chamber 26 and cathode chamber 27 has a function as a concentration chamber. Anode chamber 26 is filled with an anion exchange resin (AER) or a cation exchange resin (CER), hydrogen peroxide removal chamber 23 is filled with a catalyst-supported anion exchange resin (Cat. AER), and cathode chamber 27 is filled with an anion exchange resin (AER) or a cation exchange resin (CER). This hydrogen peroxide removing apparatus is the same as the hydrogen peroxide removing apparatus shown in FIG. 2 except that anode chamber 26 and cathode chamber 27 are provided with the function as concentration chambers 22, 24, respectively, and concentration chambers 22, 24 are not provided instead. Therefore, the hydrogen peroxide removing apparatus shown in FIG. 8 operates in the same manner as the hydrogen peroxide removing apparatus shown in FIG. 2.

### Second Embodiment

Next, a hydrogen peroxide removing apparatus according to the second embodiment of the present invention will be described. In the hydrogen peroxide removing apparatus of the first embodiment, a deionization chamber may be provided between anode 11 and cathode 12 so as to be adjacent to hydrogen peroxide removal chamber 23 via an intermediate ion exchange membrane on the cathode side or the anode side of hydrogen peroxide removal chamber 23, and the processed water obtained by passing the water to be processed through the hydrogen peroxide removal chamber may be passed through the deionization chamber. The deionization chamber is filled with an ion exchanger. In this configuration, it is possible to simultaneously perform removal of hydrogen peroxide from the water to be processed and deionization, and it becomes possible to produce pure water of high purity as well as ultrapure water. The intermediate ion exchange membrane may be an anion exchange membrane or a cation exchange membrane, and may be a composite membrane such as a bipolar membrane.

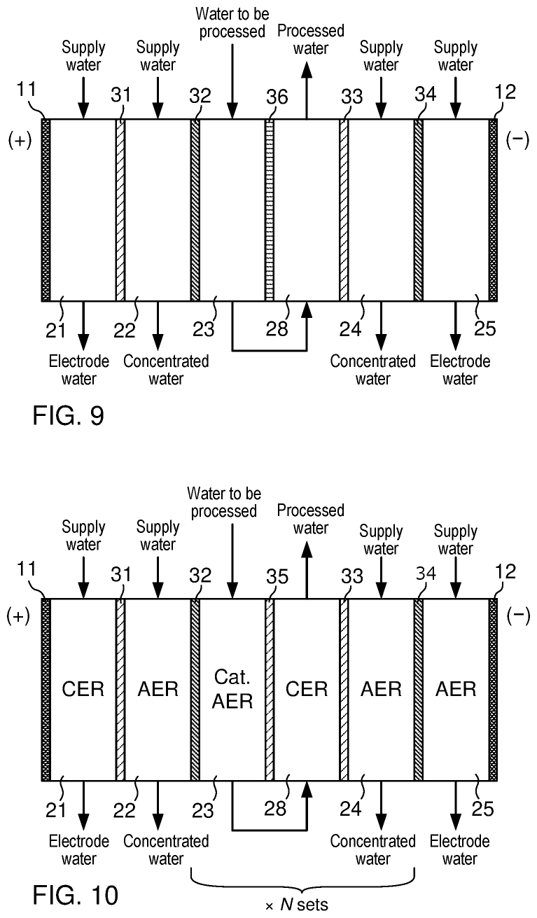

FIG. 9 shows a hydrogen peroxide removing apparatus according to the second embodiment. The hydrogen peroxide removing apparatus illustrated is one in which intermediate ion exchange membrane 36 is disposed in place of the second ion exchange membrane of the hydrogen peroxide removing apparatus shown in FIG. 1. On a side facing cathode 12 of intermediate ion exchange membrane 36, deionization chamber 28 filled with an ion exchanger is provided, a second ion exchange membrane is disposed between deionization chamber 28 and cathode chamber 25, and the processed water treated in hydrogen peroxide removal chamber 23 is passed through deionization chamber 28. The packing ratio of the ion exchanger in hydrogen peroxide removal chamber 23 is preferably set to 95% or more and 125% or less as in the case of the first embodiment. In the illustrated example, anode 11, anode chamber 21, cation exchange membrane 31, first concentration chamber 22, anion exchange membrane 32, hydrogen peroxide removal chamber 23, intermediate ion exchange membrane 36, deionization chamber 28, cation exchange membrane 33, second concentration chamber 24, anion exchange membrane 34, cathode chamber 25 and cathode 12 are arranged in this order.

FIG. 10 illustrates one of the specific examples of the hydrogen peroxide removal apparatus of the second embodiment. The hydrogen peroxide removing apparatus shown in FIG. 10 is one obtained by placing deionization chamber 28 between hydrogen peroxide removal chamber 23 and second concentration chamber 24 in the hydrogen peroxide removing apparatus shown in FIG. 2. Deionization chamber 28 is filled with a cation exchange resin (CER). Hydrogen peroxide removal chamber 23 and deionization chamber 28 are partitioned by cation exchange membrane 35 which is an intermediate ion exchange membrane, and deionization chamber 28 and second concentration chamber 24 are partitioned by cation exchange membrane 33 which is the second ion exchange membrane. The water to be processed is supplied to hydrogen peroxide removal chamber 23, and, after the hydrogen peroxide is decomposed and removed in hydrogen peroxide removal chamber 23, is passed through deionization chamber 28. The processed water from which the hydrogen peroxide has been removed and which has been subjected to the deionization treatment is discharged from deionization chamber 28. Also in the hydrogen peroxide removing apparatus shown in FIG. 10, using a configuration from anion exchange membrane 32 to second concentration chamber 24 as a repeating unit X, a plurality of repeating unit X can be provided in series between first concentration chamber 22 adjacent to anode chamber 21 and anion exchange membrane 34 adjacent to cathode chamber 25.

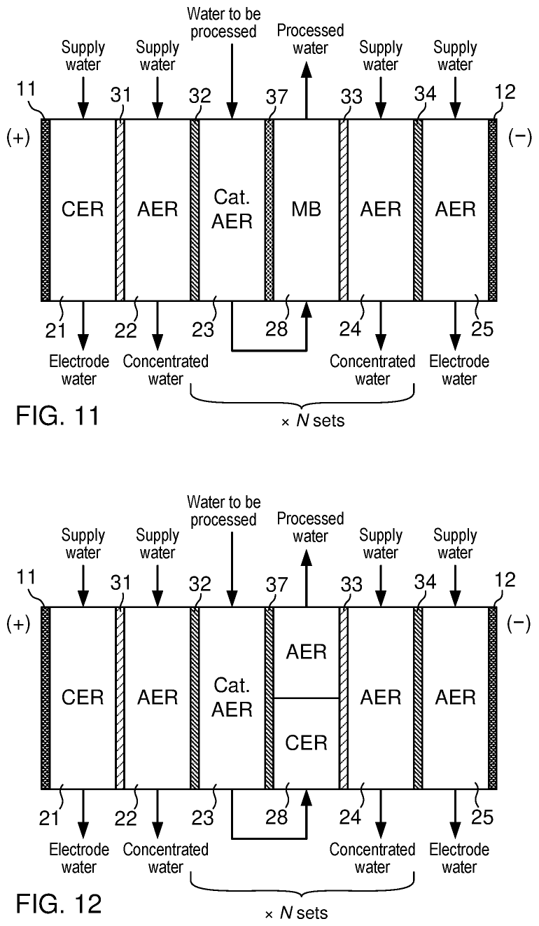

The hydrogen peroxide removing apparatus shown in FIG. 11 is different from the hydrogen peroxide removing apparatus shown in FIG. 10 in that the anion exchange resin and the cation exchange resin are filled in deionization chamber 28 in a mixed bed (MB) form. In FIG. 11, the intermediate ion exchange membrane partitioning hydrogen peroxide removal chamber 23 and deionization chamber 28 is constituted by anion exchange membrane 37.

The hydrogen peroxide removing apparatus shown in FIG. 12 is different from the hydrogen peroxide removing apparatus shown in FIG. 10 in that anion exchange membrane 37 is used as the intermediate ion exchange membrane partitioning hydrogen peroxide removal chamber 23 and deionization chamber 28, and, in deionization chamber 28, the layer of the cation exchange resin (CER) and the layer of the anion exchange resin (AER) are alternately arranged along the flow direction of water in this order so that they are filled in a multilayered bed configuration. Deionization chamber 28 and concentration chamber 24 on the side of cathode 12 are partitioned by cation exchange membrane 33.

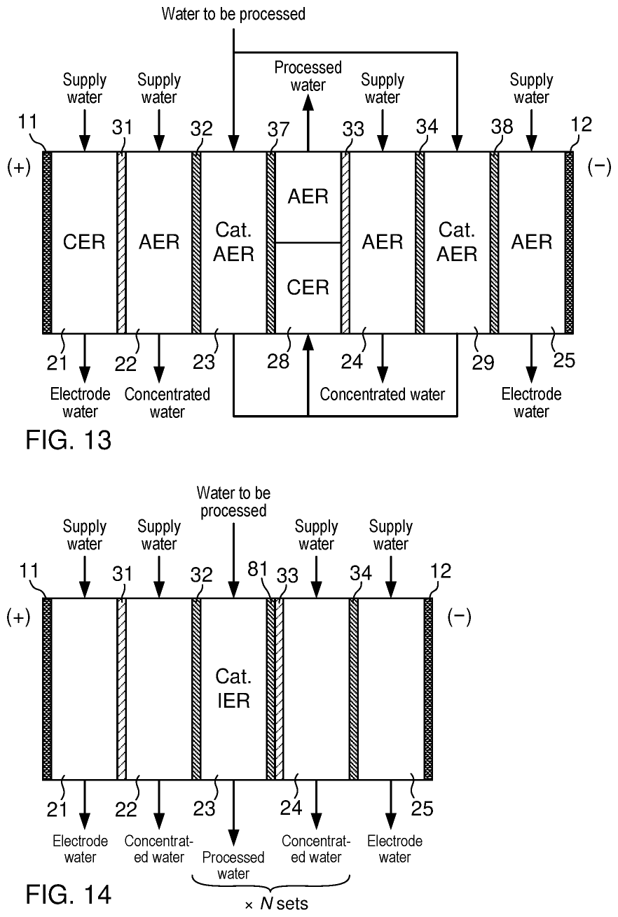

The hydrogen peroxide removing apparatus shown in FIG. 13 is an apparatus in which, in the hydrogen peroxide removing apparatus shown in FIG. 12, hydrogen peroxide removal chamber 29 serving as an auxiliary is arranged between concentration chamber 24 and cathode chamber 25 on the side of cathode 12. Hydrogen peroxide removal chamber 29 is also filled with an anion exchanger on which the platinum group metal catalyst is supported (Cat. AER). With regard to the packing ratio of the catalyst-supported anion exchange resin (Cat. AER) in hydrogen peroxide removal chamber 29, it is preferable that the packing ratio is 95% or more and 125% or less. The water to be processed is also supplied to hydrogen peroxide removal chamber 29 serving as an auxiliary. Water discharged from hydrogen peroxide removal chamber 29 is supplied to deionization chamber 28 by merging with water discharged from hydrogen peroxide removal chamber 23. Concentration chamber 24 and hydrogen peroxide removal chamber 29 are adjacent to each other with anion exchange membrane 34 interposed therebetween, and hydrogen peroxide removal chamber 29 and cathode chamber 25 are adjacent to each other with anion exchange membrane 38 interposed therebetween. Since the hydrogen peroxide removing apparatus shown in FIG. 13 has a plurality of hydrogen peroxide removal chambers 23, 29, removal of hydrogen peroxide can be performed more efficiently.

### Third Embodiment

The hydroxide ion utilized for regeneration of the ion exchanger in hydrogen peroxide removal chamber 23 in the hydrogen peroxide removing apparatus of the first embodiment is generated by a dissociation reaction of water occurring at a point where the anion exchange resin and the cation exchange membrane come into contact with each other or at a point where the anion exchange resin and the cation exchange resin come into contact with each other. Since the area where the ion exchange resin and the ion exchange membrane come into contact with each other and the area where the ion exchange resins come into contact with each other are small, the amount of generated hydroxide ions used for regeneration of the ion exchanger in hydrogen peroxide removal chamber 23 is also small. If a large amount of hydroxide ions can be supplied into hydrogen peroxide removal chamber 23, the regeneration efficiency of the ion exchanger can be further improved, and the effective electric resistance of hydrogen peroxide removal chamber 23 can be further reduced. Therefore, in the hydrogen peroxide removing apparatus according to the third embodiment, a superposition in which a cation exchange membrane and an anion exchange membrane are superposed on each other is arranged between hydrogen peroxide removal chamber 23 and cathode 12 so that the cation exchange membrane is located on a side facing cathode 12 and the anion exchange membrane is located on a side facing hydrogen peroxide removal chamber 23. With this configuration, when a DC voltage is applied between anode 11 and cathode 12, the dissociation reaction of water proceeds at the interface between the cation exchange membrane and the anion exchange membrane due to the potential difference generated by the current, and the hydroxide ions are supplied from the anion exchange membrane to the hydrogen peroxide removal chamber. As a result, the electric resistance between anode 11 and cathode 12 becomes smaller, so that a large current can be flowed through the hydrogen peroxide removal chamber at a low voltage, and regeneration of the ion exchanger in hydrogen peroxide removal chamber 23 can be promoted. When the cation exchange membrane and the anion exchange membrane are superposed, they may be simply superposed on each other, or may be configured as a bipolar membrane by arranging a catalyst which promotes the dissociation reaction of water at an interface between them.

FIG. 14 shows the configuration of the hydrogen peroxide removing apparatus of the third embodiment. This hydrogen peroxide removing apparatus is one obtained by arranging, in the hydrogen peroxide removing apparatus shown in FIG. 1, anion exchange membrane 81 on one surface, which is on a side facing hydrogen peroxide removal chamber 23, of cation exchange membrane 33 partitioning hydrogen peroxide removal chamber 23 and second concentrating chamber 24, so that anion exchange membrane 81 and cation exchange membrane 33 are superposed on each other. Specifically, in the hydrogen peroxide removing apparatus shown in FIG. 14, anode 11 and cathode 12 are facing each other, and anode chamber 21, first concentration chamber 22, hydrogen peroxide removal chamber 23, second concentration chamber 24, and cathode chamber 25 are disposed between anode 11 and cathode 12 in this order from the side of anode 11. Anode chamber 21 and first concentration chamber 22 are partitioned by cation exchange membrane 31, and first concentration chamber 22 and hydrogen peroxide removal chamber 23 are partitioned by anion exchange membrane 32. Hydrogen peroxide removal chamber 23 and second concentrating chamber 24 are partitioned by a superposition in which anion exchange membrane 81 and cation exchange membrane 33 are superposed with each other. Second concentration chamber 24 and cathode chamber 25 are partitioned by anion exchange membrane 34. Similarly to the hydrogen peroxide removing apparatus shown in FIG. 1, each of anode chamber 21, first concentrating chamber 22, second concentrating chamber 24 and cathode chamber 25 is filled with an ion exchanger not supporting a platinum group metal catalyst. Also in this embodiment, it is preferable that the packing ratio of the ion exchanger in hydrogen peroxide removal chamber 23 is set to 95% or more and 125% or less. By setting the packing ratio to 95% or more and 125% or less, it is possible to further improve the regeneration efficiency of the ion exchanger and to further reduce the effective electric resistance of hydrogen peroxide removal chamber 23.

Next, the operation of the hydrogen peroxide removing apparatus shown in FIG. 14 will be explained. When hydrogen peroxide is removed from the water to be processed which contains hydrogen peroxide, as in the case of the apparatus shown in FIG. 1, the supply water is passed through each of anode chamber 21, centration chambers 22, 24 and cathode chamber 25, and the water to be processed is passed through hydrogen peroxide removal chamber 23 in a state in which a DC voltage is applied between anode 11 and cathode 12. When the water to be processed which contains hydrogen peroxide is passed through hydrogen peroxide removal chamber 23, hydrogen peroxide in the water to be processed is decomposed into water and oxygen by a catalytic reaction between the hydrogen peroxide and the platinum group metal catalyst supported on the ion exchanger in hydrogen peroxide removal chamber 23, and as a result, the processed water from which hydrogen peroxide is removed flows out from hydrogen peroxide removal chamber 23. At this time, in hydrogen peroxide removal chamber 23, a dissociation reaction of water (H₂O→H⁺+OH⁻) occurs due to a potential difference generated at an interface between different kinds of ion exchangeable substances by the applied current, and hydrogen ions and hydroxide ions are generated. The interface between different kinds of exchangeable substances is, for example, an interface between an anion exchange membrane and a cation exchanger, an interface between a cation exchange membrane and an anion exchanger, an interface between a cation exchanger and an anion exchanger, or an interface between an anion exchange membrane and a cation exchange membrane. By the hydrogen ions and the hydroxide ions thus generated, the ion component previously adsorbed on the ion exchanger in hydrogen peroxide removal chamber 23 is ion-exchanged and desorbed from the ion exchanger. Of the desorbed ionic components, anions move through anion exchange membrane 32 to first concentration chamber 22 closer to anode 11, and are discharged as concentrated water from first concentration chamber 22. Eventually, the anionic component in the water to be processed supplied to hydrogen peroxide removal chamber 23 is transferred to first concentration chamber 22 and discharged, and at the same time, the ion exchanger of hydrogen peroxide removal chamber 23 is also regenerated. The electrode water is discharged from each of anode chamber 21 and cathode chamber 25. Note that, the application of the DC voltage may be continuously performed at the time of passing the water to be processed, or may be performed intermittently. With respect to the supply water passing through concentration chambers 22, 24 and the electrode chambers (i.e., anode chamber 21 and cathode chamber 25), the same conditions as those described in the first embodiment are applied.

In the hydrogen peroxide removing apparatus shown in FIG. 14, the dissociation reaction of water proceeds efficiently at the interface between anion exchange membrane 81 and cation exchange membrane 33, and a large amount of hydroxide ions are supplied into hydrogen peroxide removal chamber 23 via anion exchange membrane 81. Since the effective electric resistance of hydrogen peroxide removal chamber 23 can be reduced by supplying a large amount of hydroxide ions, the DC voltage applied between anode 11 and cathode 12 for the electric regeneration of the anion exchanger in hydrogen peroxide removal chamber 23 can also be reduced.

In the configuration shown in FIG. 14, similar to that described in the first embodiment, a plurality of repeating units X can be provided in series between concentration chamber 22 adjacent to anode chamber 21 and anion exchange membrane 34 partitioning cathode chamber 25 when the repeating unit X has a configuration composed of [anion exchange membrane (AEM) 32|hydrogen peroxide removal chamber (H) 23|anion exchange membrane (AEM) 81|cation exchange membrane (CEM) 33|concentration chamber (C) 24]. In such a series configuration, with respect to hydrogen peroxide removal chamber 23 closest to anode chamber 21, anode chamber 21 itself can function as concentration chamber 22 without independently interposing concentration chamber 22 between anode chamber 21 and hydrogen peroxide removal chamber 23. Similarly, with respect to hydrogen peroxide removal chamber 23 closest to cathode chamber 25, cathode chamber 25 itself can function as concentration chamber 24 without independently interposing concentration chamber 24 between cathode chamber 25 and hydrogen peroxide removal chamber 23.

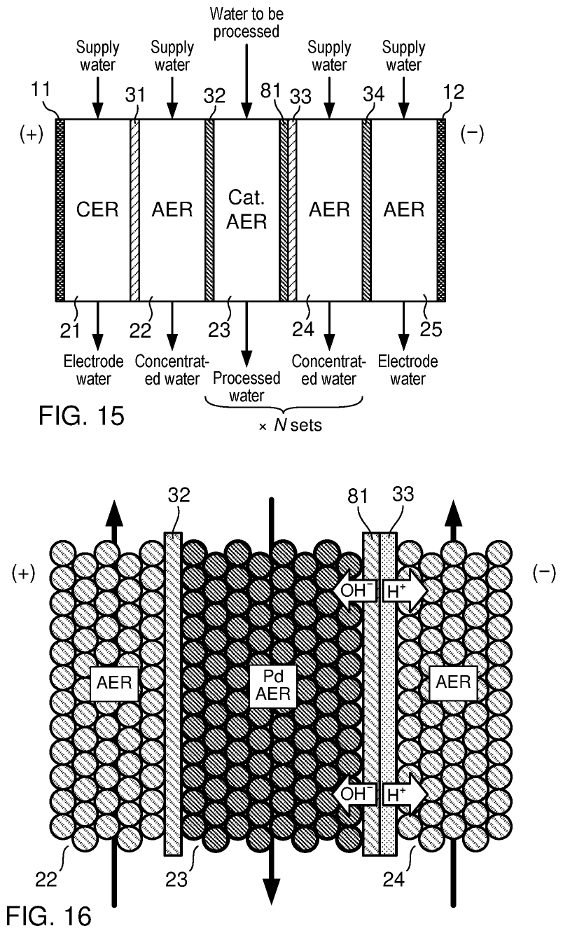

FIG. 15 shows an example in which, in the configuration shown in FIG. 14, anode chamber 21 is filled with a cation exchange resin (CER), concentration chambers 22, 24 and cathode chamber 25 are filled with an anion exchange resin (AER), and hydrogen peroxide removal chamber 23 is filled with a catalyst-supported anion exchange resin (Cat. AER). In other words, the hydrogen peroxide removing apparatus shown in FIG. 15 is configured such that, in the apparatus shown in FIG. 2, anion exchange membrane 81 is arranged on one surface, which is on the side facing hydrogen peroxide removing chamber 23, of cation exchange membrane 33 partitioning hydrogen peroxide removal chamber 23 and concentration chamber 24 so that anion exchange membrane 81 and cation exchange membrane 33 are superposed on each other. When the TOC component in the water to be processed is decomposed and removed by an ultraviolet oxidation device, the water discharged from the ultraviolet oxidation device contains a carbonic acid component and a minute amount of hydrogen peroxide. When such water is used as water to be processed and hydrogen peroxide is decomposed and removed from the water to be processed, it is preferable that the carbonic acid component can also be removed together with the removal of hydrogen peroxide. In the apparatus shown in FIG. 15, since the hydroxide ions generated by the water dissociation reaction are supplied via anion exchange membrane 81, the inside of hydrogen peroxide removal chamber 23 becomes a basic environment, and the carbonic acid component in the water to be processed adsorbs to the anion exchanger as carbonate ions or bicarbonate ions, and then is ion-exchanged by the hydroxide ions and moves to concentration chamber 22 via anion exchange membrane 32. The regeneration of anion exchangers by hydroxide ions is also promoted. Therefore, in the hydrogen peroxide removing apparatus shown in FIG. 15, it is possible to decompose and remove hydrogen peroxide in the water to be processed, it is also possible to efficiently remove the carbonic acid component from the water to be processed.

Also in the hydrogen peroxide removing apparatus shown in FIG. 15, similarly to that shown in FIG. 3, the processed water after the hydrogen peroxide is removed in hydrogen peroxide removal chamber 23 can be used as the supply water to anode chamber 21, first concentration chamber 22, second concentration chamber 24 and cathode chamber 25. Specifically, portions of the process water obtained from hydrogen peroxide removal chamber 23 are passed through concentration chambers 22, 24, and are discharged as concentrated water, respectively, and a portion of the processed water is passed through cathode chamber 25, and the discharged electrode water can be further passed through anode chamber 21.

FIG. 16 is a view illustrating specifically the operation of the hydrogen peroxide removing apparatus shown in FIG. 15, and showing hydrogen peroxide removal chamber 23 and its vicinity. Among hydrogen peroxide removal chamber 23 and concentration chambers 22, 24 on both sides thereof, the flows of water are in an opposite direction as indicated by an arrow. Here, the platinum group metal catalyst is made of palladium (Pd) and a particulate anion exchange resin (Pd AER) on which the palladium catalyst is supported is filled in hydrogen peroxide removal chamber 23 as an anion exchanger. A granular anion exchange resin in which a metal catalyst is not supported is filled in concentration chambers 22, 24 as an anion exchanger. As shown, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions, and the hydrogen ions move to concentration chamber 24 via cation exchange membrane 33, and the hydroxide ions move to hydrogen peroxide removal chamber 23 via anion exchange membrane 81. In the following description, a particulate anion exchange resin (Pd AER) on which the palladium catalyst is supported is also referred to as a Pd-supported anion exchange resin (Pd AER).

In the configuration shown in FIGS. 15 and 16, it is assumed that anion exchange membrane 81 is not superposed on cation exchange membrane 33, and hydrogen peroxide removal chamber 23 and concentration chamber 24 on the side of cathode 12 thereof are partitioned only by cation exchange membrane 33. In this case, at a position where the Pd-supported anion exchange resin (Pd AER) is in contact with cation exchange membrane 33 in hydrogen peroxide removal chamber 23, a weak acid component such as, for example, free carbonic acid that has diffused from concentration chamber 24 through cation exchange membrane 33 can be ionized by an ion exchange reaction and captured. For example, carbonic acid is converted into carbonate ions or bicarbonate ions by the Pd-supported anion exchange resin (Pd AER) and captured. The captured anions are movable through the Pd-supported anion exchange resin (Pd AER) to concentration chamber 22 on the side of anode 11. On the other hand, in a portion where cation exchange membrane 33 is not in contact with the Pd-supported anion exchange resin (Pd AER), it is considered that a weak acid component is released from cation exchange membrane 33 into the liquid phase in hydrogen peroxide removal chamber 23, and a portion thereof is mixed into the processed water as it is.

In order to prevent the weak acid component from being mixed into the processed water discharged from hydrogen peroxide removal chamber 23, it is also effective to superpose anion exchange membrane 81 on cation exchange membrane 33. When anion exchange membrane 81 is superposed on cation exchange membrane 33, the weak acid component diffused to the side of hydrogen peroxide removal chamber 23 via cation exchange membrane 33 permeates through anion exchange membrane 81. At this time, the weak acid component is converted from a neutral molecule to an anion by ion exchange inside anion exchange membrane 81, and thus becomes an ionic form which is easily captured in the Pd-supported anion exchange resin (Pd AER) inside hydrogen peroxide removal chamber 23. As a result, incorporation of a weak acid component into the processed water is reduced.

Also in the hydrogen peroxide removing device of the third embodiment, as in the apparatus of the first embodiment, an ion exchanger on which a metal catalyst is not supported can be filled in hydrogen peroxide removal chamber 23, in addition to the anion exchanger (Cat. AER) on which the platinum group metal catalyst is supported. Hereinafter, such examples will be described.

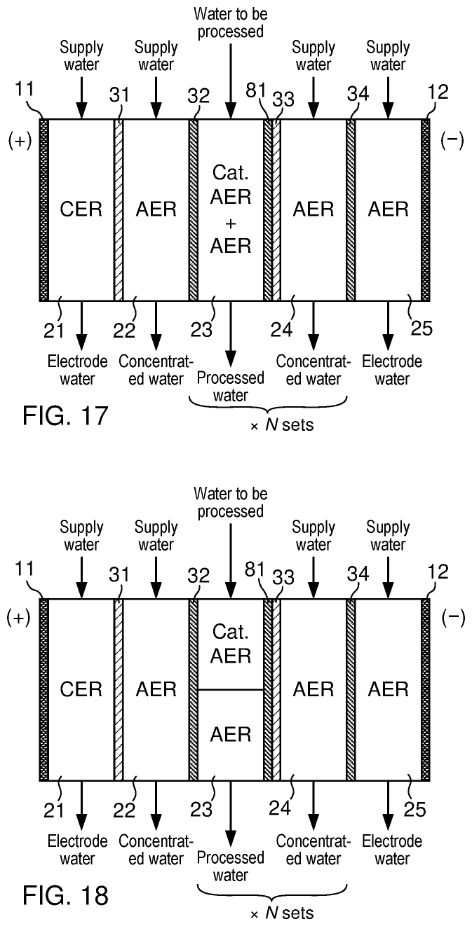

In the hydrogen peroxide removing device shown in FIG. 17, a catalyst-supported anion exchange resin (Cat. AER) and an anion exchange resin (AER) ware filled in hydrogen peroxide removal chamber 23 in a manner in which both resins are mixed. Note that, a cation exchange resin (CER) may be mixed with the catalyst-supported anion exchange resin (Cat. AER) in place of the anion exchange resin (AER) and filled. Even in this configuration, since the amount of the expensive platinum group metal catalyst to be used can be reduced as compared with a case where only the catalyst-supported anion exchange resin (Cat. AER) is filled in hydrogen peroxide removal chamber 23, the cost can be reduced.

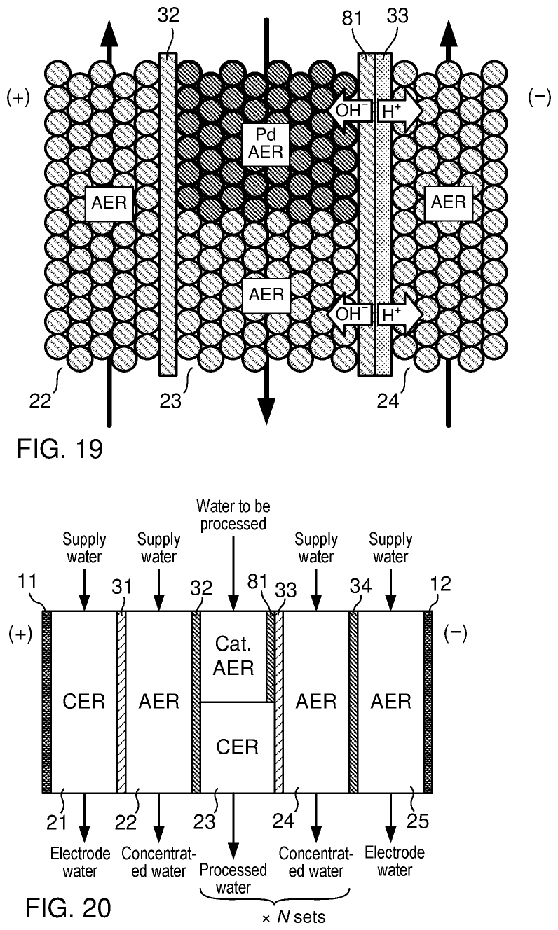

In the hydrogen peroxide removing apparatus shown in FIG. 18, a layer of the catalyst-supported anion exchange resin (Cat. AER) and a layer of the anion exchange resin (AER) are filled in hydrogen peroxide removal chamber 23 in a multilayered bed configuration in which these layers are alternately arranged so that the layer of the catalyst-supported anion exchange resin (Cat. AER) becomes an upstream side along the flow of water. FIG. 19 is a view illustrating specifically the operation of the hydrogen peroxide removing apparatus shown in FIG. 18, and showing hydrogen peroxide removal chamber 23 and its vicinity. It is assumed that a palladium catalyst is used as the platinum group metal catalyst. As in the case described in FIG. 16, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions. The hydroxide ions migrate from anion exchange membrane 81 to both the layer of the anion exchange resin on which the palladium catalyst is supported, that is, the layer of the Pd-supported anion exchange resin (Pd AER), and the layer of the anion exchange resin (AER) not supporting the metal catalyst. In this hydrogen peroxide removing apparatus, decomposition and removal of hydrogen peroxide is performed in the vicinity of the inlet of the water to be processed in hydrogen peroxide removal chamber 23, and a deionization treatment on the anion is performed in entire hydrogen peroxide removal chamber 23.

The hydrogen peroxide removing apparatus shown in FIG. 20 is obtained by, in hydrogen peroxide removal chamber 23 of the hydrogen peroxide removing apparatus shown in FIG. 18, filling a cation exchange resin (CER) instead of the anion exchange resin (AER). Therefore, in hydrogen peroxide removal chamber 23, the layer of the catalyst-supported anion exchange resin (Cat. AER) and the layer of the cation exchange resin (CER) are filled in a multilayered bed configuration so that the layer of the catalyst-supported anion exchange resin (Cat. AER) becomes an upstream side along the flow of water. Then, in this multilayered bed configuration, anion exchange membrane 81 is not provided at a position where the cation exchange resin (CER) is formed, and the cation exchange resin (CER) and the cation exchange membrane 33 are in direct contact with each other at that position.

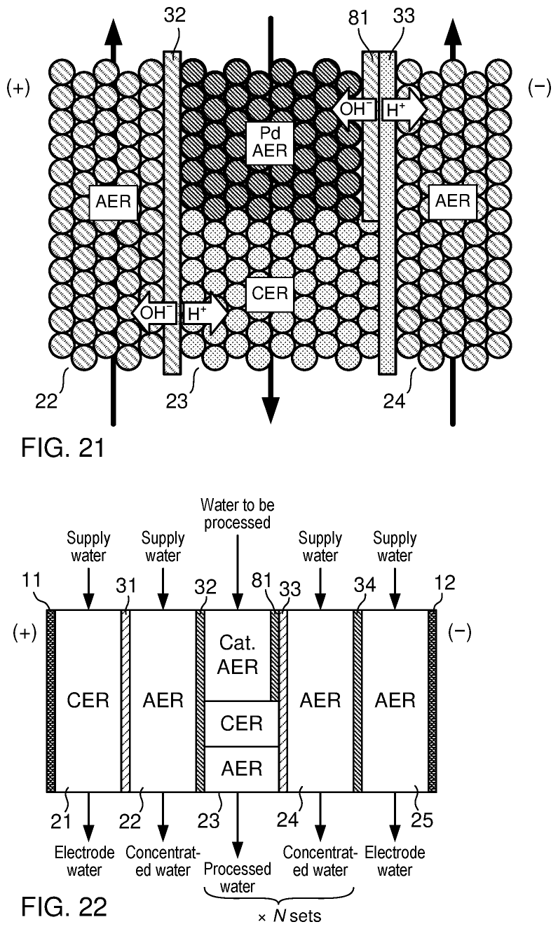

FIG. 21 is a view illustrating specifically the operation of the hydrogen peroxide removing apparatus shown in FIG. 20, and showing hydrogen peroxide removal chamber 23 and its vicinity. It is assumed that a palladium catalyst is used as the platinum group metal catalyst. As described in FIG. 16, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions. The hydrogen ions move to concentration chamber 24 via cation exchange membrane 33, and the hydroxide ions move to hydrogen peroxide removal chamber 23 via anion exchange membrane 81. Further, water is dissociated even at an interface between anion exchange membrane 32 and the cation exchange resin (CER) in hydrogen peroxide removal chamber 23, and hydrogen ions and hydroxide ions are generated. The hydrogen ions diffuse inside the cation exchange resin (CER) to regenerate the cation exchange resin (CER). The cation desorbed from the cation exchange resin (CER) in hydrogen peroxide removal chamber 23 moves through the cation exchange resin (CER) at a position not superposed on anion exchange membrane 81 to concentration chamber 24 on the side of cathode 12. Therefore, in the hydrogen peroxide removing apparatus shown in FIG. 20, removal of hydrogen peroxide and deionization treatment for both anions and cations are performed in hydrogen peroxide removal chamber 23, and, at the same time, regeneration of both the catalyst-supported anion exchange resin (Cat. AER) and the cation exchange resin (CER) is performed.

In the hydrogen peroxide removing apparatus shown in FIG. 22, a layer of catalyst-supported anion exchange resin (Cat. AER), a layer of cation exchange resin (CER) and a layer of anion exchange resin (AER) are filled in hydrogen peroxide removal chamber 23 in a multilayer bed configuration in this order from the upstream side along the flow of water. Anion exchange membrane 81 overlapping each other with cation exchange membrane 33 is provided at a position where the layer of the catalyst-supported anion exchange resin (Cat. AER) is formed, and the cation exchange resin (CER) and the anion exchange resin (AER) are in direct contact with cation exchange membrane 33. Note that, anion exchange membrane 81 overlapping each other with cation exchange membrane 33 may be provided not only at the position where the layer of the catalyst-supported anion exchange resin (Cat. AER) is formed but also at the position where the anion exchange resin (AER) is formed.

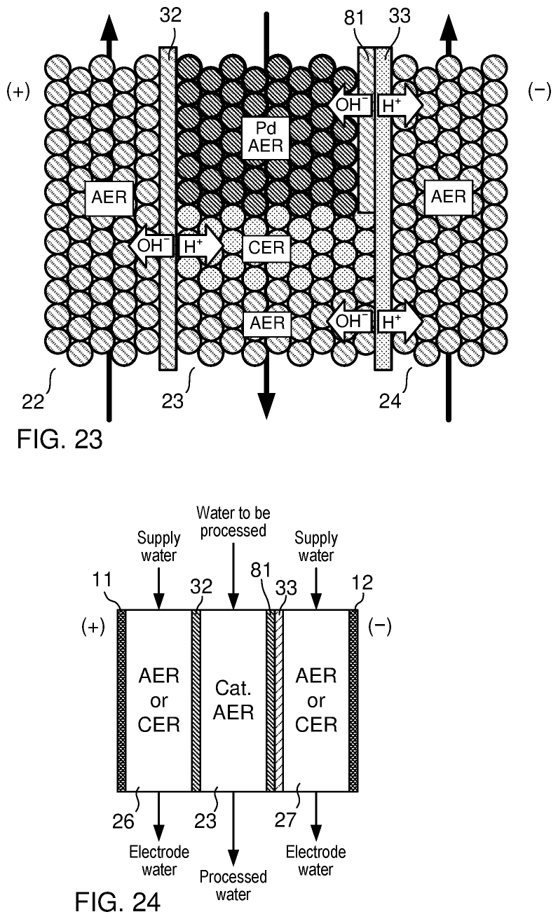

FIG. 23 is a view illustrating specifically the operation of the hydrogen peroxide removing apparatus shown in FIG. 22, and showing hydrogen peroxide removal chamber 23 and its vicinity. It is assumed that a palladium catalyst is used as the platinum group metal catalyst. As in the case described in FIG. 16, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions. The hydroxide ions migrate from anion exchange membrane 81 into the layer of Pd-supported anion exchange resin (Pd AER). At the same time, water is dissociated even at the interface between anion exchange membrane 32 and the cation exchange resin (CER) in hydrogen peroxide removal chamber 23 and at the interface between the anion exchange resin (AER) in hydrogen peroxide removal chamber 23 and cation exchange membrane 33 to generate hydrogen ions and hydroxide ions. The hydrogen ions generated at the interface with anion exchange membrane 32 diffuse in the cation exchange resin (CER) and regenerate the cation exchange resin (CER). The hydroxide ions generated at the interface with cation exchange membrane 33 diffuse in the anion exchange resin (AER) to regenerate this anion exchange resin (AER). Also in hydrogen peroxide removal chamber 23 of this hydrogen peroxide removing apparatus, removal of hydrogen peroxide and deionization treatment for both anions and cations are performed, and regeneration of the respective ion exchange resins is simultaneously performed.

Also in the hydrogen peroxide removing apparatuses described with reference to FIGS. 18 to 23, since hydrogen peroxide removal chamber 23 has a multilayered bed configuration, the amount of the expensive platinum group metal catalyst to be used can be reduced as compared with the case where only the catalyst-supported anion exchange resin (Cat. AER) is filled in hydrogen peroxide removal chamber 23, the cost can be reduced.

As described above, the anode chamber can also function as a concentration chamber without providing the concentration chamber adjacent to the anode chamber, and similarly, the cathode chamber can also function as a concentration chamber without providing the concentration chamber adjacent to the cathode chamber. In the hydrogen peroxide removing apparatus shown in FIG. 24, anode 11, anode chamber 26, anion exchange membrane 32, hydrogen peroxide removal chamber 23, anion exchange membrane 81, cation exchange membrane 33, cathode chamber 27 and cathode 12 are arranged in this order. Each of anode chamber 26 and cathode chamber 27 has a function as a concentration chamber. Anode chamber 26 is filled with an anion exchange resin (AER) or a cation exchange resin (CER), hydrogen peroxide removal chamber 23 is filled with a catalyst-supported anion exchange resin (Cat. AER), and the cathode chamber 27 is filled with an anion exchange resin (AER) or a cation exchange resin (CER). This hydrogen peroxide removing apparatus is the same as the hydrogen peroxide removing apparatus shown in FIG. 15 except that anode chamber 26 and cathode chamber 27 are provided with the function as concentration chambers 22, 24, respectively, and concentration chambers 22, 24 are not provided instead. Therefore, the hydrogen peroxide removing apparatus shown in FIG. 24 operates in the same manner as the hydrogen peroxide removing apparatus shown in FIG. 15.

### Fourth Embodiment

Next, a hydrogen peroxide removing apparatus according to a fourth embodiment of the present invention will be described. The hydrogen peroxide removing apparatus is one obtained by arranging, between hydrogen peroxide removal chamber 23 and cathode 12, a superposition in which a cation exchange membrane and an anion exchange membrane are superpose on each other in order to increase the amount of hydroxide ions supplied to hydrogen peroxide removal chamber 23 so that the cation exchange membrane is on the side of cathode 12 and the anion exchange membrane is on the side of hydrogen peroxide removal chamber 23, in the hydrogen peroxide removing apparatus of the second embodiment described above. In this case, the intermediate ion exchange membrane itself partitioning hydrogen peroxide removal chamber 23 and deionization chamber 28 may be a superpotition in which the anion exchange membrane and the cation exchange membrane are superposed on each other so that the anion exchange membrane is on the side of hydrogen peroxide removal chamber 23. Alternatively, when at least an anion exchange resin is filled in deionization chamber 28, the intermediate ion exchange membrane may be used as an anion exchange membrane, and deionization chamber 28 may be partitioned on the side thereof facing cathode 12 by a superposition in which an anion exchange membrane and a cation exchange membrane are superposed on each other so that the anion exchange membrane is on the side of hydrogen peroxide removal chamber 23. Also in this embodiment, it is preferable that the packing ratio of the ion exchanger in hydrogen peroxide removal chamber 23 is set to 95% or more and 125% or less.

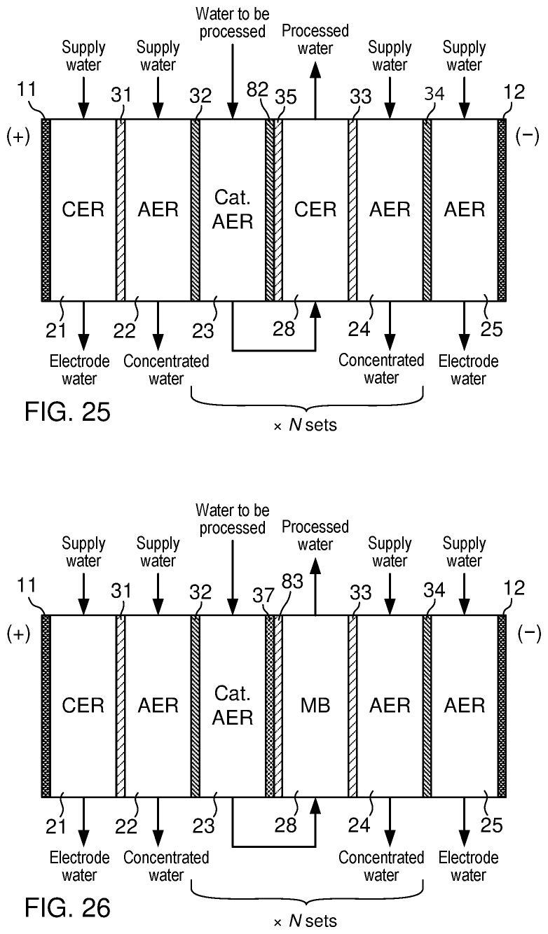

FIG. 25 illustrates one of the specific examples of the hydrogen peroxide removing apparatus of the fourth embodiment. The hydrogen peroxide removing apparatus shown in FIG. 25 is one in which deionization chamber 28 is disposed between hydrogen peroxide removal chamber 23 and second concentration chamber 24, in the hydrogen peroxide removing apparatus shown in FIG. 15. Deionization chamber 28 is filled with a cation exchange resin (CER). Hydrogen peroxide removal chamber 23 and deionization chamber 28 are partitioned by a superposition in which anion exchange membrane 82 and cation exchange membrane 35 are superposed on each other so that anion exchange membrane 82 is on the side of hydrogen peroxide removal chamber 23. Deionization chamber 28 and second concentration chamber 24 are partitioned by cation exchange membrane 33. The superposition of anion exchange membrane 82 and cation exchange membrane 35 corresponds to the intermediate ion exchange membrane. The water to be processed is supplied to hydrogen peroxide removal chamber 23, and then passed through deionization chamber 28 after the hydrogen peroxide is decomposed and removed in hydrogen peroxide removal chamber 23. The processed water from which the hydrogen peroxide has been removed and subjected to the deionization treatment is discharged from deionization chamber 28. Also in the hydrogen peroxide removing apparatus shown in FIG. 25, using the section from anion exchange membrane 32 to second concentration chamber 24 as a repeating unit X, a plurality of repeating units X can be provided in series between first concentration chamber 22 adjacent to anode chamber 21 and anion exchange membrane 34 in adjacent to cathode chamber 25.

In the hydrogen peroxide removing apparatus shown in FIG. 25, the dissociation reaction of water occurs at the interface between anion exchange membrane 82 and cation exchange membrane 35 to generate hydrogen ions and hydroxide ions, and the hydroxide ions are supplied to hydrogen peroxide removal chamber 23, so that the effective electric resistance of hydrogen peroxide removal chamber 23 decreases. Also, regeneration of the anion exchange resin in hydrogen peroxide removal chamber 23 is promoted. This is advantageous with respect to removing anionic components, in particular a carbonic acid component, together with the removal of hydrogen peroxide.

The hydrogen peroxide removing apparatus shown in FIG. 26 is different from the hydrogen peroxide removing apparatus shown in FIG. 25 in that the anion exchange resin and the cation exchange resin are filled in deionization chamber 28 in a mixed bed (MB) manner. In FIG. 26, the intermediate ion exchange membrane partitioning hydrogen peroxide removal chamber 23 and deionization chamber 28 is a superposition in which anion exchange membrane 37 disposed on the side of hydrogen peroxide removal chamber 23 and cation exchange membrane 83 disposed on the side of deionization chamber 28 are superposed on each other.

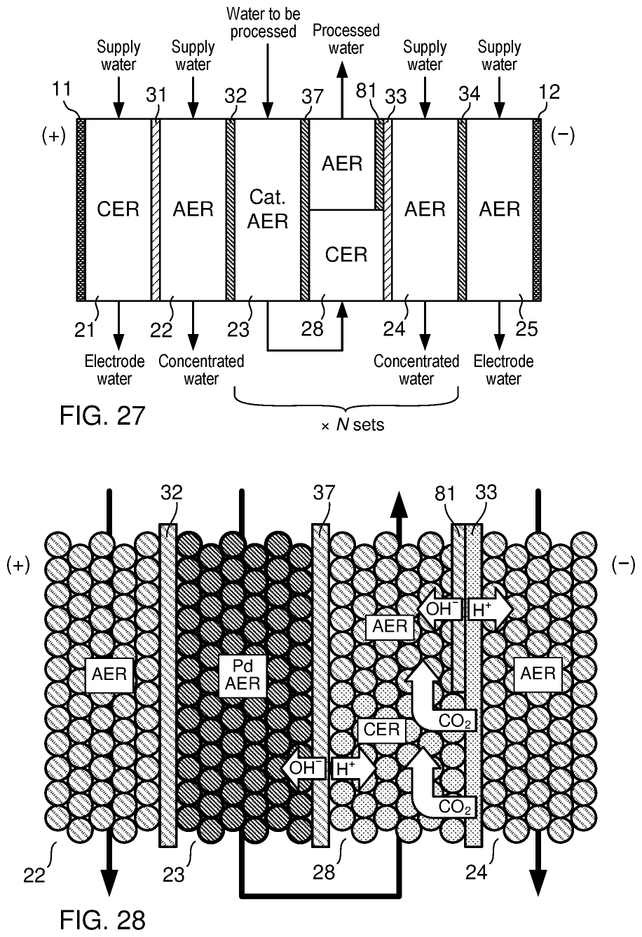

The hydrogen peroxide removing device shown in FIG. 27 is different from the hydrogen peroxide removing apparatus shown in FIG. 25 in that anion exchange membrane 37 is used as the intermediate ion exchange membrane partitioning hydrogen peroxide removal chamber 23 and deionization chamber 28, and, in deionization chamber 28, the layer of the cation exchange resin (CER) and the layer of the anion exchange resin (AER) are filled in a multilayered bed configuration so that they are alternately arranged in this order along the flow direction of water. Although deionization chamber 28 and concentration chamber 24 on the side of cathode 12 are partitioned by cation exchange membrane 33, at a position where the anion exchange resin (AER) is filled in deionization chamber 28, anion exchange membrane 81 is disposed on the side of anode 11 than cation exchange membrane 33 so that anion exchange membrane 81 and cation exchange membrane 33 overlap each other.

FIG. 28 is a view illustrating specifically the operation of the hydrogen peroxide removing apparatus shown in FIG. 27, and showing hydrogen peroxide removal chamber 23, deionization chamber 28 and their vicinity. It is assumed that a palladium catalyst is used as the platinum group metal catalyst. As in the case described in FIG. 16, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions. The hydroxide ions diffuse through the anion exchange resin (AER) in deionization chamber 28 and move through anion exchange membrane 37 which is the intermediate ion exchange membrane to hydrogen peroxide removal chamber 23. Further, the dissociation reaction of water at the interface between anion exchange membrane 37 and cation exchange resin (CER) in deionization chamber 28 proceeds to generate hydrogen ions and hydroxide ions, and the hydrogen ion diffuses in the cation exchange resin (CER). Since hydrogen ions diffuse, a region filled with the cation exchange resin (CER) in deionization chamber 28 becomes an acidic environment, and a carbonic acid component in the water to be processed is converted to free carbonic acid (CO₂). This free carbonic acid reaches a region filled with the anion exchange resin (AER) in deionization chamber 28, and since this region is a basic environment, the free carbonic acid is adsorbed on the anion exchange resin as carbonate ions or bicarbonate ions, and further moves to concentration chamber 22 via anion exchange membrane 37, hydrogen peroxide removal chamber 23 and anion exchange membrane 32.

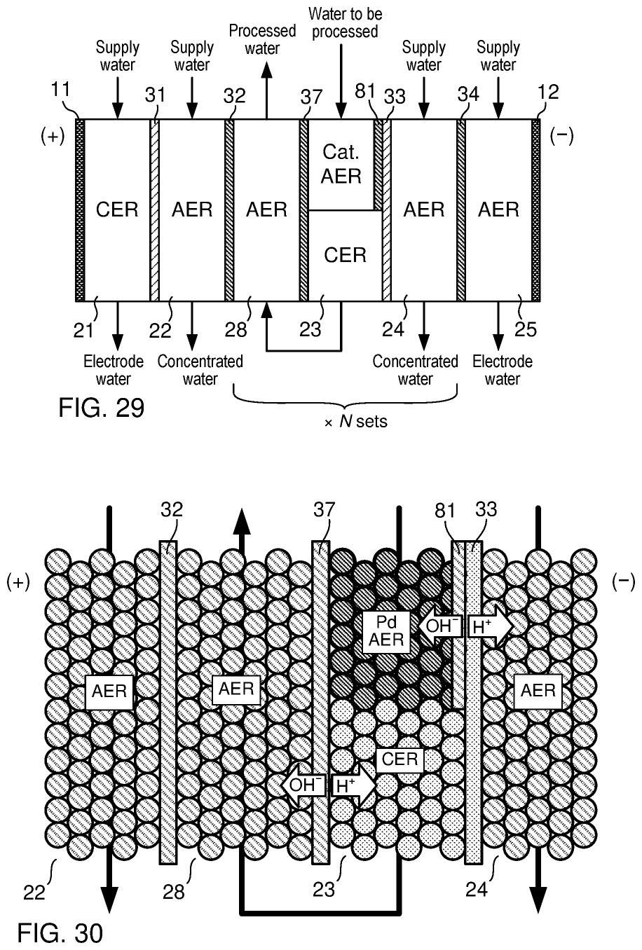

The hydrogen peroxide removing apparatus shown in FIG. 29 is an apparatus in which, in the hydrogen peroxide removing apparatus shown in FIG. 27, hydrogen peroxide removal chamber 23 and deionization chamber 28 are transposed so that deionization chamber 28 is located on the side of anode 11 with regard to intervening anion exchange membrane 37 which is the intermediate ion exchange membrane and hydrogen peroxide removal chamber 23 is located on the side of cathode 12. In hydrogen peroxide removal chamber 23, a catalyst-supported anion exchange resin (Cat. AER) is disposed on an inlet side of the water to be processed, and a cation exchange resin (CER) is disposed on an outlet side. Although hydrogen peroxide removal chamber 23 and concentration chamber 24 on the side of cathode 12 are partitioned by cation exchange membrane 33, and, at a position where the catalyst-supported anion exchange resin (Cat. AER) is provided, anion exchange membrane 81 is superposed on the anode 11 side of cation exchange membrane 33 and the layer of the catalyst-supported anion exchange resin (Cat. AER) is in contact with anion exchange membrane 81. The layer of cation exchange resin (CER) is in direct contact with cation exchange membrane 33. Deionization chamber 28 is filled with an anion exchange resin (AER). The water to be processed is supplied to deionization chamber 28 after passing through hydrogen peroxide removal chamber 23. The processed water from which hydrogen peroxide has been removed and which has been subjected to the deionization treatment is discharged from deionization chamber 28.

FIG. 30 is a view illustrating specifically the operation of the hydrogen peroxide removing apparatus shown in FIG. 29, and showing hydrogen peroxide removal chamber 23, deionization chamber 28 and their vicinity. It is assumed that a palladium catalyst is used as the platinum group metal catalyst. As in the case described in FIG. 16, when a DC current is applied between anode 11 and cathode 12, the dissociation reaction of water proceeds at the interface between anion exchange membrane 81 and cation exchange membrane 33 due to the potential difference generated by the current to generate hydrogen ions and hydroxide ions. The hydroxide ions are supplied to the layer of Pd-supported anion exchange resin (AER) in hydrogen peroxide removal chamber 23. Also at the interface of anion exchange membrane 37 which is an intermediate ion exchange membrane and the cation exchange resin (CER) in hydrogen peroxide removal chamber 23, the dissociation reaction of water proceeds, and the hydrogen ions generated at this time are supplied to the cation exchange resin (CER) in hydrogen peroxide removal chamber 23.

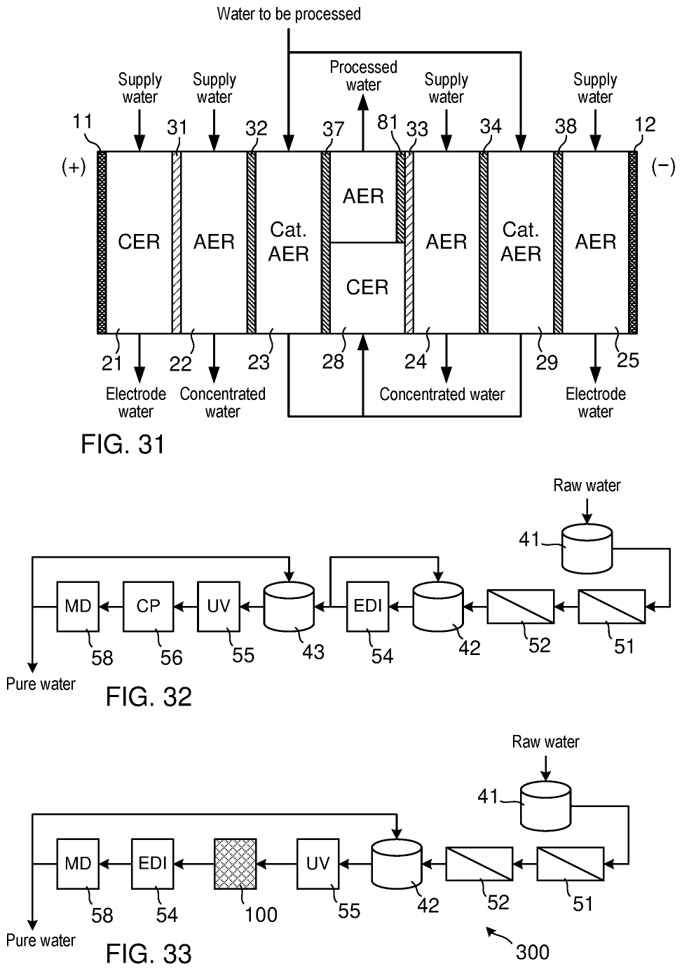

The hydrogen peroxide removing apparatus shown in FIG. 31 is an apparatus in which, in hydrogen peroxide removing apparatus shown in FIG. 27, hydrogen peroxide removal chamber 29 serving as an auxiliary is arranged between concentration chamber 24 on the side of cathode 12 and cathode chamber 25. Also this hydrogen peroxide removal chamber 29 is filled with an anion exchanger (Cat. AER) on which a platinum group metal catalyst is supported, and supplied with the water to be processed. Water discharged from hydrogen peroxide removal chamber 29 is supplied to deionization chamber 28 by merging with water discharged from hydrogen peroxide removal chamber 23. Concentration chamber 24 and hydrogen peroxide removal chamber 29 are adjacent to each other with anion exchange membrane 34 interposed therebetween, and hydrogen peroxide removal chamber 29 and cathode chamber 25 are adjacent to each other with anion exchange membrane 38 interposed therebetween. Since the hydrogen peroxide removing apparatus shown in FIG. 31 has a plurality of hydrogen peroxide removal chambers 23, 29, removal of hydrogen peroxide can be performed more efficiently.

The anion exchanger used in the hydrogen peroxide removing apparatus according to the present invention is not particularly limited, regardless of whether it is used for supporting a metal catalyst or not, and a monolithic porous anion exchanger or an anion exchange resin is suitably used as the anion exchanger. Further, there is no particular limitation on the anion exchange membrane, and, for example, a homogeneous anion exchange membrane or a heterogeneous anion exchange membrane is suitably used as the anion exchange membrane. Furthermore, there is no particular limitation on the cation exchanger, and a monolithic porous cation exchanger or a cation exchange resin is suitably used as the cation exchanger. Still further, there is no particular limitation on the cation exchange membrane, and, for example, a homogeneous cation exchange membrane or a heterogeneous cation exchange membrane is suitably used as the cation exchange membrane. In addition, the intermediate ion exchange membrane is not particularly limited, and for example, a homogeneous anion exchange membrane or a heterogeneous anion exchange membrane, a homogeneous cation exchange membrane or a heterogeneous cation exchange membrane, a bipolar membrane, or the like is suitably used as the intermediate ion exchange membrane.

Although there is no particular limitation on the resin serving as a matrix of the anion exchange resin or the cation exchange resin, a resin containing an organic polymer having a three dimensional network structure is preferred as the matrix, and examples of the organic polymer serving as a matrix include a copolymer of styrene-divinylbenzene (i.e., styrene-based), a copolymer of acrylic-divinylbenzene (i.e., acrylic-based), and so on.

Further, examples of types of the anion exchanger include a weakly-basic anion exchanger, a strongly-basic anion exchanger, and so on. Examples of types of the cation exchanger include a weakly-acidic cation exchanger, a strongly-acidic cation exchanger, and so on. An ion exchanger supporting a platinum group metal catalyst used in the present invention is one in which particles of a platinum group metal catalyst are supported on the above cation exchanger or anion exchanger.

There is no particular limitation on the method for producing an ion exchanger on which the platinum group metal catalyst is supported and which is used in the present invention. An ion exchanger on which a platinum group metal catalyst is supported can be obtained by supporting particles of a platinum group metal on an ion exchanger by a known method. For example, there is a method in which an anion exchanger is immersed in an aqueous hydrochloric acid solution of palladium chloride to adsorb chloropalladate anions to the anion exchanger by ion exchange, and then contacted with a reducing agent to support palladium metal nanoparticles on the anion exchanger. Alternatively, there is a method in which an anion exchanger is packed in a column, an aqueous hydrochloric acid solution of palladium chloride is passed through the column to adsorb chloropalladate anions to the anion exchanger by ion exchange, and then a reducing agent is passed through the column to support palladium metal nanoparticles on the anion exchanger. There is no particular limitation on the reducing agent used in these processes, and the reducing agents include: alcohols such as methanol, ethanol, and isopropanol; carboxylic acids such as formic acid, oxalic acid, citric acid, and ascorbic acid; ketones such as acetone and methyl ethyl ketone; aldehydes such as formaldehyde and acetaldehyde; sodium borohydride; hydrazine; and so on.

The water to be processed supplied to the hydrogen peroxide removing apparatus according to the present invention is not particularly limited as long as it contains hydrogen peroxide. The concentration of hydrogen peroxide can include, for example, 1 μg/L or more, 5 μg/L or more, 10 μg/L or more, 100 μg/L or more, and 1000 μg/L or more. Further, the water to be processed may contain a carbonic acid component. Here, the carbic acid component refers to H₂CO₃, HCO₃⁻, CO₃²⁻. The carbonic acid component is generated, for example, when decomposition and removal of TOC components is performed by an ultraviolet oxidation device. In this description, the total amount of these carbonic acid components is referred to as “total carbonic acid,” and the concentration thereof is expressed as CO₂-converted concentration (as CO₂). The concentration of the total carbonic acid of the water to be processed is not particularly limited, and examples thereof include those having 0.01 mg/L (as CO₂) or more, 0.1 mg/L (as CO₂) or more, and 1.0 mg/L (as CO₂) or more. There is no particular limitation on the electric conductivity of the water to be processed, and examples thereof include those having 0.1 μS/cm or more, and 1 μS/cm or more. Further, the water to be processed may contain salt components such as sodium. The concentration of sodium contained in the water to be processed is not particularly limited, and examples thereof include 1 μg/L or more, 10 μg/L or more, 100 μg/L or more, and so on.

In the present invention, there is no particular limitation on the passing-water space velocity of the water to be processed with respect to the filling volume of the ion exchanger on which the platinum group metal catalyst is supported, as long as hydrogen peroxide can be removed, and examples thereof include 10 h⁻¹ or more, 100 h⁻¹ or more, and 200 h⁻¹ or more. Further, there is no particular limitation on the removal ratio of hydrogen peroxide removed from the water to be processed, and examples thereof include 60% or more, 80% or more, 90% or more, and 95% or more.

In the present invention, it is preferable that the thickness of hydrogen peroxide removal chamber 23 is set to 9 mm or more and 30 mm or less. Here, the thickness of hydrogen peroxide removal chamber 23 is a size of hydrogen peroxide removal chamber 23 along the direction of voltage application when a DC voltage is applied between anode 11 and cathode 12, and the thickness direction of hydrogen peroxide removal chamber 23 is generally orthogonal to the flow direction of the water to be processed in hydrogen peroxide removal chamber 23. If the thickness of hydrogen peroxide removal chamber 23 is too small, the flow rate of the water to be processed which can be processed becomes too small. On the other hand, if the thickness of hydrogen peroxide removal chamber 23 is too large, the DC voltage to be applied between anode 11 and cathode 12 becomes excessively high, and since the amount of hydroxide ions and hydrogen ions generated by dissociation of water is insufficient as compared with the amount of the ion exchanger, electric regeneration of the ion exchanger in hydrogen peroxide removal chamber 23 is not sufficiently performed.

The hydrogen peroxide removing apparatus according to the present invention can be incorporated into, for example, a pure water producing apparatus or an ultrapure water producing apparatus. Hereinafter, a pure water producing apparatus and an ultrapure water producing apparatus incorporating a hydrogen peroxide removing apparatus according to the present invention will be described.

FIG. 32 shows an example of a configuration of a pure water producing apparatus in the prior art. In this pure water producing apparatus, raw water tank 41 storing raw water, first reverse osmosis membrane device 51, second reverse osmosis membrane device 52, reverse osmosis membrane treated water tank 42, electrodeionization device (EDI) 54, EDI treated water tank 43, ultraviolet oxidation device (UV) 55, non-regeneration type ion exchange resin (CP) 56 and degassing membrane (MD) 58 are arranged in this order, and the raw water is processed in this order. As a result, pure water is finally produced. In this pure water producing apparatus, when the facility at the later stage becomes full capacity, a circulation operation in the system is to be performed, the ion exchanger in electrodeionization device 54 may be oxidized and deteriorated by the hydrogen peroxide generated from ultraviolet oxidation device 55. Therefore, when circulating water in the system, it is necessary to circulate the produced pure water to EDI treated water tank 43 and to circulate the processed water of electrodeionization device 54 to reverse osmosis membrane treated water tank 42 so that the processed water of ultraviolet oxidation device 55 does not circulate to electrodeionization device 54. Such a pure water production apparatus requires a plurality of lines for circulation and the EDI treated water tank, resulting in a complicated configuration.

FIG. 33 shows an example of a configuration of a pure water producing apparatus equipped with a hydrogen peroxide removing apparatus according to the present invention. In the illustrated pure water producing apparatus 300, raw water tank 41, first reverse osmosis membrane device 51, second reverse osmosis membrane device 52, reverse osmosis membrane treated water tank 42, ultraviolet oxidation device (UV) 55, hydrogen peroxide removing apparatus 100, electrodeionization device (EDI) 54, and degassing membrane (MD) 58 are arranged in this order, and the raw water is processed in this order, and as a result, pure water is produced. Hydrogen peroxide removing apparatus 100 used here may be any apparatus as long as it is a hydrogen peroxide removing apparatus according to the present invention, but it is preferable to use any of the hydrogen peroxide removing apparatuses shown in FIGS. 1 to 31. In this pure water producing apparatus, when the facility at the later stage, which is a destination of the pure water, becomes full capacity, the produced pure water is circulated to reverse osmosis membrane treated water tank 42. In other words, by disposing hydrogen peroxide removing apparatus 100 at a stage subsequent to ultraviolet oxidation device 55, it is possible to avoid an influence on electrodeionization device 54 due to hydrogen peroxide generated by ultraviolet oxidation device 55. Further, since hydrogen peroxide removing apparatus 100 itself has the same deionizing performance as that of an electrodeionization device as will be apparent from the above description, it is possible to obtain, by this configuration, pure water of high purity equivalent to that in the case where the electrodeionization devices are arranged in two stages in series. Depending on the deionizing performance required for the pure water producing apparatus, the outlet water of hydrogen peroxide removing apparatus 100 may be supplied to degassing membrane (MD) 58 as it is without providing electrodeionization device (EDI) 54. By reducing the number of systems in which the processed water is circulated to one system, an EDI treated water tank and a circulation line of the EDI treated water, which are required by the apparatus shown in FIG. 32, become unnecessary. A pure water producing apparatus having a low cost can be obtained.

Note that, in FIG. 33, at least a portion of the processed water of degassing membrane (MD) 58 is circulated to reverse osmosis membrane treated water tank 42, but the processed water of hydrogen peroxide removing apparatus 100 or electrodeionization device (EDI) 54 may be circulated to reverse osmosis membrane treated water tank 42. In addition, water obtained by bypassing ultraviolet oxidation device 55 may be utilized as the supply water to be passed through the concentration chambers and the electrode chambers of hydrogen peroxide removing apparatus 100, and it is preferable to do so. By utilizing water which has bypassed ultraviolet oxidation device 55, water having a low hydrogen peroxide concentration or no hydrogen peroxide is supplied to the concentration chambers and the electrode chambers, so that deterioration of the ion exchanger filled in the concentration chambers and the electrode chambers can be suppressed.

In the pure water producing apparatus, a carbonic acid removing means may be provided at a stage preceding the hydrogen peroxide removing apparatus. When the carbonic acid component in the water to be processed which is supplied to the hydrogen peroxide removing apparatus becomes small, it becomes possible to reduce the voltage applied to the hydrogen peroxide removing apparatus and to reduce the power consumption. As the carbonic acid removing means, a reverse osmosis membrane (RO) device, an additive of a basic agent to a reverse osmosis membrane device, and further, although not shown in FIG. 33, a degassing membrane (MD), a decarboxylation tower, an anion exchange resin tower, and the like can be used.

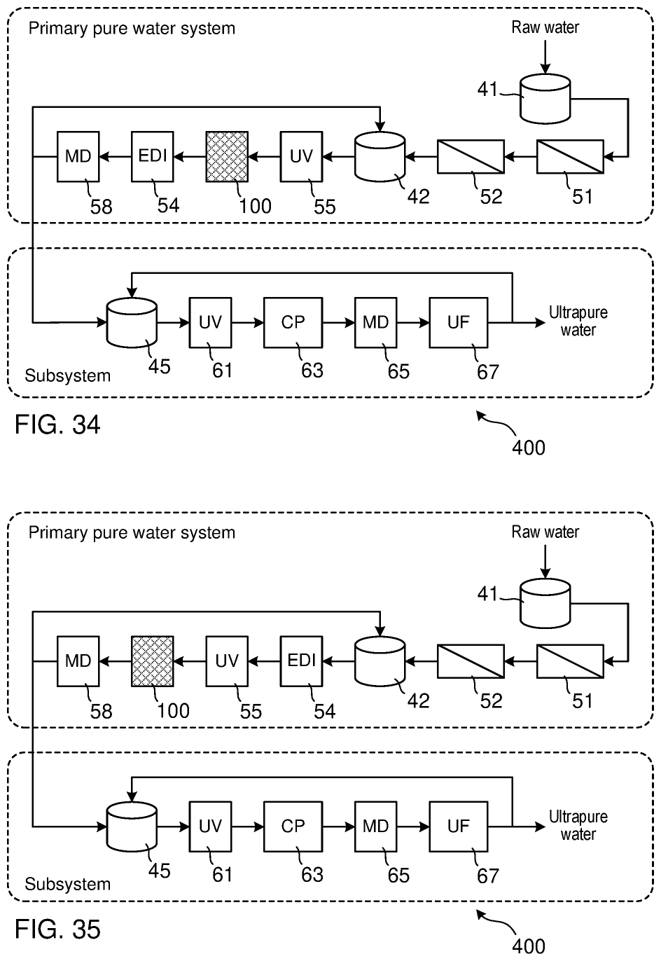

FIG. 34 shows an example of a configuration of an ultrapure water producing apparatus in which the hydrogen peroxide removing apparatus according to the present invention is incorporated. Ultrapure water producing apparatus 400 illustrated uses pure water producing apparatus 300 shown in FIG. 33 as a primary pure water system, and further includes a subsystem arranged therein to produce ultrapure water. In the subsystem, pure water tank 45 for storing primary pure water from the primary pure water system is provided, and ultraviolet oxidization device (UV) 61, non-regenerative type ion exchange resin (CP) 63, degassing membrane (MD) 65 and ultrafiltration membrane (UF) 67 are arranged in this order with respect to an outlet of pure water tank 45. Primary pure water is processed in this order to produce ultrapure water. A portion of the ultrapure water produced is circulated to pure water tank 45. A microfiltration membrane may be used instead of ultrafiltration membrane (UF) 67. In addition, it is also possible to have a configuration in which electrodeionization device (EDI) 54 is not provided in the primary pure water system.

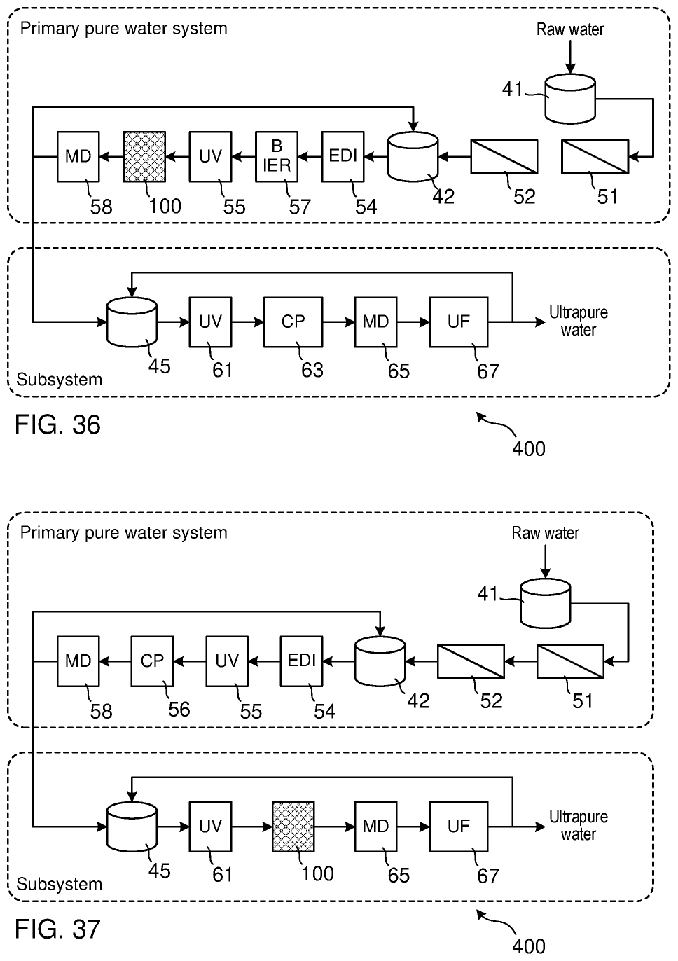

The ultrapure water producing apparatus shown in FIG. 35 is an apparatus in which the arrangement order of ultraviolet oxidization device (UV) 55, hydrogen peroxide removing apparatus 100 and electrodeionization device (EDI) 54 in the primary pure water system of the ultrapure water producing apparatus shown in FIG. 34 is replaced with the arrangement order of electrodeionization device (EDI) 54, ultraviolet oxidizer (UV) 55 and hydrogen peroxide removing apparatus 100. Further, the ultrapure water producing apparatus shown in FIG. 36 is an apparatus in which a boron removing device such as boron-selective ion exchange resin (B IER) 57 or a boron selective adsorbent is provided at a position which is a subsequent stage of electrodeionization device (EDI) 54 and becomes a preceding stage of ultraviolet oxidation device (UV), in the primary pure water system of the ultrapure water producing apparatus shown in FIG. 35.

In the ultrapure water producing apparatus, hydrogen peroxide removing apparatus 100 according to the present invention can also be arranged in a subsystem. FIG. 37 shows an apparatus in which, in the ultrapure water producing apparatus shown in FIG. 35, hydrogen peroxide removing apparatus 100 are removed from the primary pure water system so that the outlet water of ultraviolet oxidization device (UV) 55 is supplied to degassing membrane (MD) 58 as it is and, in the subsystem, hydrogen peroxide removing apparatus 100 is provided instead of non-regenerative ion exchange resin (CP) 63. In the primary pure water system, non-regenerative ion exchange resin (CP) 56 is provided instead of hydrogen peroxide removing apparatus 100. Since hydrogen peroxide removing device 100 can have a deionizing performance, even if hydrogen peroxide removing device 100 is provided instead of non-regenerative type ion exchange resin (CP) 63 in the subsystem, the water quality of the ultrapure water obtained as the outlet water of ultrafiltration membrane (UF) 67 does not deteriorate. In the subsystem, non-regenerative ion exchange resin (CP) 63 may be left as it is to provide hydrogen peroxide removing apparatus 100. In this way, the ion component which has not been removed by hydrogen peroxide removing apparatus 100 can be removed by non-regenerative ion exchange resin (CP) 63, and further, the hydrogen peroxide which cannot be removed by non-regenerative ion exchange resin (CP) 63 can be removed, and the respective functions can be complemented. When both of hydrogen peroxide removing apparatus 100 and non-regenerative ion exchange resin (CP) 63 are provided in series, water may be passed through hydrogen peroxide removing apparatus 100 first or through non-regenerative ion exchange resin (CP) 63 first.

### EXAMPLES

Next, the present invention will be described in more detail by way of Examples and Comparative Examples.

### Example 1 and Comparative Example 1

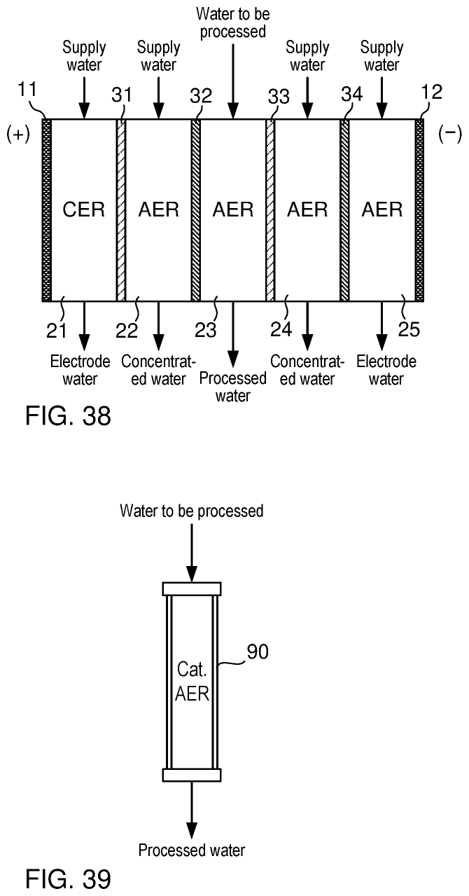

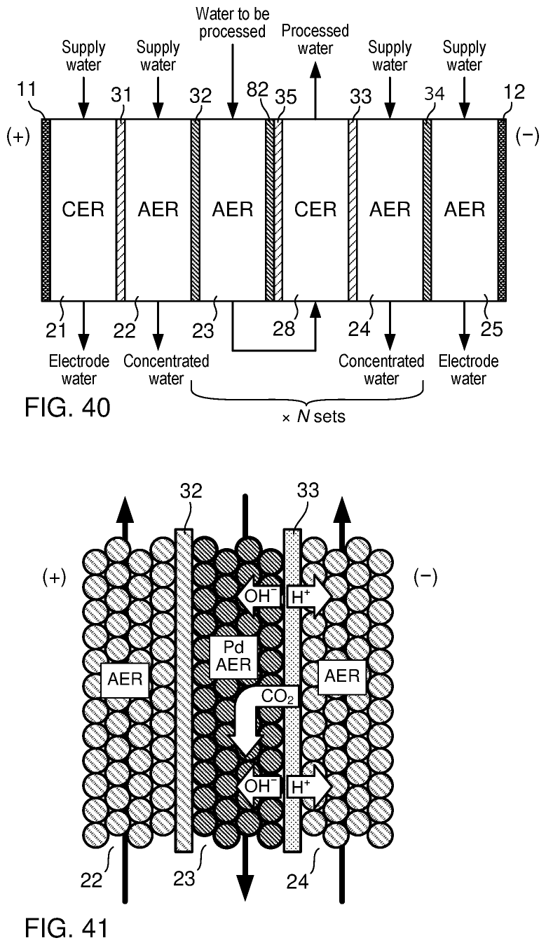

Using the apparatuses shown in FIG. 2, FIG. 10, FIG. 38, FIG. 39 and FIG. 40, and using water to be processed each having water quality shown as Condition 1 to Condition 7 in Table 1 as the water to be processed, a test for removing hydrogen peroxide from the water to be processed was performed to determine the hydrogen peroxide removal ratio and the electrical resistivity of the processed water after performing passing the water to be processed through the apparatus for about 100 hours. The results are described in Table 2 to Table 5. Also described in Table 2 to Table 5 are: the flow rate of the water to be processed; the value of the current applied between anode 11 and cathode 12; the figure number for indicating in which figure the used apparatus is illustrated; and the condition number for indicating which condition shown in Table 1 is the water quality condition of the water to be processed which was used.

The concentration of total carbonic acid in the water to be processed was calculated from the measured inorganic carbon (IC) concentration using a TOC meter (Sievers™ M9e, manufactured by SUEZ Co., Ltd.) by the following method.

Total carbonic acid concentration [mg/L (as CO₂)]=Inorganic carbon (IC) concentration [mg/L (as C)]×3.364

Here, 3.664 is a factor used for converting an amount of carbon (C) into a corresponding amount of total carbonic acid (CO₂), which is calculated by the following formulae.

Molecular weight of CO₂=44.01 [g/mol]

Atomic weight of C=12.01 [g/mol]

44.01 [g/mol]/12.01 [g/mol]=3.364

### Examples 1-1 to 1-7

The hydrogen peroxide removing apparatus shown in FIG. 2 was used. Anode chamber 21 was filled with a styrene-based, gel-type strongly-acidic cation exchange resin (AMBERJET® manufactured by DuPont Inc.). Concentration chambers 22, 24 and cathode chamber 25 were filled with a styrene-based, gel-type strongly-basic anion exchange resin (AMBERJET® manufactured by DuPont Inc.). As anion exchange membranes 32, 34, a homogeneous anion exchange membrane (NEOSEPTA® manufactured by Astom Corporation) was used, and a homogeneous cation exchange membrane (NEOSEPTA® manufactured by Astom Corporation) was used for cation exchange membranes 31, 33. In hydrogen peroxide removal chamber 23, a cell frame body having an opening area of 10 cm×10 cm and a thickness of 1 cm was filled with 100 mL of a Pd catalyst-supported anion exchange resin as the platinum group metal catalyst-supported anion exchange resin. Incidentally, since the area of the electrode in this case is 1 dm², the value of the current value (A) is the same value, even if converted to the current density (A/dm²).

### Example 1-8

The hydrogen peroxide removing apparatus shown in FIG. 10 was used. In hydrogen peroxide removal chamber 23, a cell frame body having an opening area of 10 cm×10 cm and a thickness of 1 cm was filled with 100 mL of a Pd catalyst-supported anion exchange resin as the platinum group metal catalyst-supported anion exchange resin. In deionization chamber 28, a cell frame body having an opening area of 10 cm×10 cm and a thickness of 1 cm was filled with 100 mL of a styrene-based, gel-type strongly-acidic cation exchange resin (AMBERJET® manufactured by DuPont Inc.). As cation exchange membranes 33, 35, a homogeneous cation exchange membrane (NEOSEPTA® manufactured by Astom Corporation) was used. The configuration of the other ion exchange membranes, the electrode chambers and the concentration chambers is the same as in Example 1-1.

### Comparative Examples 1-1, 1-3, 1-5, 1-7, 1-9, 1-11 and 1-13

A hydrogen peroxide removing apparatus shown in FIG. 38 was used. The hydrogen peroxide removing apparatus shown in FIG. 38 was one obtained by, in the hydrogen peroxide removing apparatus used in Example 1-1, filling hydrogen peroxide removal chamber 23 with 100 mL of a styrene-based, gel-type strongly-basic anion exchange resin (AMBERJET® manufactured by DuPont Inc.) which did not support a catalyst.

### Comparative Examples 1-2, 1-4, 1-6, 1-8, 1-10, 1-12 and 1-14

A device having the configuration shown in FIG. 39 was used. The device shown in FIG. 39 is a device in which column 90 having an inner diameter of 5 cm is filled with 100 mL of the same platinum group metal catalyst-supported anion exchange resin as that used in Example 1-1.

### Comparative Example 1-15

The hydrogen peroxide removing apparatus shown in FIG. 40 was used. The hydrogen peroxide removing apparatus shown in FIG. 40 was one obtained by, in the hydrogen peroxide removing apparatus used in Example 1-8m filling hydrogen peroxide removal chamber 23 with a styrene-based, gel-type strongly-basic anion exchange resin (AMBERJET® manufactured by DuPont Inc.) which did not not support a catalyst.

TABLE 1

| | | Concentration | Total | |
|---|---|---|---|---|
| | Electric | of hydrogen | carbonic | Sodium |
| | conductivity | peroxide | acid (μg/L | concentration |
| | (μS/cm) | (μg/L) | (as CO₂)) | (μg/L) |
| Condition 1 | 0.1 | 106 | 0.01 | <1 |
| Condition 2 | 1.6 | 103 | 1.64 | <1 |
| Condition 3 | 1.3 | 6 | 1.60 | — |
| Condition 4 | 1.6 | 1048 | 1.66 | — |
| Condition 5 | 1.6 | 96 | 1.67 | — |
| Condition 6 | 1.6 | 97 | 1.64 | — |
| Condition 7 | 1.3 | 114 | 1.60 | 69 |

<Influence of Total Carbonic Acid>

The effect of total carbon contained in the water to be processed was considered. As can be seen from Table 2, even if the concentration of total carbonic acid in the water to be processed increases, in Examples 1-1 and 1-2, the removal ratio of hydrogen peroxide is almost 100%, and the electrical resistivities in the processed water also exhibit high values of 18.1 MΩ·cm and 17.7 MSΩ·cm, respectively. In contrast, in Comparative Examples 1-1, 1-2, 1-3 and 1-4, the removal ratios of hydrogen peroxide were 7%, 99%, 17% and 58%, respectively, and the electrical resistivities of the processed water were 17.9 MΩ·cm, 16.8 MΩ·cm, 17.9 MΩ·cm and 0.6 MΩ·cm, respectively. In other words, in the results of Comparative Examples 1-1 and 1-3, when the total carbonic acid concentration of the water to be processed increased, the performance of removing hydrogen peroxide slightly improved, but it was still only an increase of 7%→17%, which is a low value. Here, from the results of Comparative Examples 1-2 and 1-4, it can be seen that, when the total carbonic acid concentration of the water to be processed increases, the removal ratio of hydrogen peroxide is remarkably lowered. On the other hand, from Examples 1-1 and 1-2, it can be seen that, according to the method based on the present invention, even if the total carbonic acid concentration of the water to be processed increases, a very good removal ratio of hydrogen peroxide can be obtained.

TABLE 2

| | | Water to be processed | | | Removal | Electrical |
|---|---|---|---|---|---|---|
| | | | Flow | Applied | ratio of | resistivity of |
| | Apparatus | | rate | current | hydrogen | processed water |
| | configuration | Condition | (L/h) | (A) | peroxide (%) | (MΩ · cm) |
| Example 1-1 | FIG. 2 | Condition 1 | 20 | 0.1 | 100 | 18.1 |
| Example 1-2 | FIG. 2 | Condition 2 | 20 | 0.1 | 99 | 17.7 |
| Comparative | FIG. 38 | Condition 1 | 20 | 0.1 | 7 | 17.9 |
| Example 1-1 | | | | | | |
| Comparative | FIG. 39 | Condition 1 | 20 | — | 99 | 16.8 |
| Example 1-2 | | | | | | |
| Comparative | FIG. 38 | Condition 2 | 20 | 0.1 | 17 | 17.9 |
| Example 1-3 | | | | | | |
| Comparative | FIG. 39 | Condition 2 | 20 | — | 58 | 0.6 |
| Example 1-4 | | | | | | |

<Hydrogen Peroxide Concentration Dependency and Applied Current Dependency of Removal Ratio>

The dependencies of the hydrogen peroxide removal ratio on the concentration of hydrogen peroxide in the water to be processed and the applied current were studied. As shown in Table 3, even if the hydrogen peroxide concentration in the water to be processed changes, the removal ratios of hydrogen peroxide are almost 100% in Examples 1-2, 1-3, 1-4 and 1-5. On the other hand, in Comparative Examples 1-3 to 1-10, the removal ratios of hydrogen peroxide were greatly reduced, and in some cases, hydrogen peroxide could not be removed at all as in Comparative Example 1-5. From these results, it was confirmed that, in the hydrogen peroxide removing apparatus according to the present invention, removal of hydrogen peroxide can be stably achieved in a wide concentration range. In particular, it was also confirmed that the present invention can further exhibit superiority in removing hydrogen peroxide when the hydrogen peroxide concentration in the water to be processed is at a low concentration. Further, comparing the result of Comparative Example 1-3 with the result of Comparative Example 1-9, the removal ratio of hydrogen peroxide increased from 17% to 24% by increasing the applied current from 0.1 A to 1 A. However, in these comparative examples, the removal ratios are still low, and it is considered difficult to achieve a removal ratio close to 100% by increasing the current value.

TABLE 3

| | | Water to be processed | | | Removal | Electrical |
|---|---|---|---|---|---|---|
| | | | Flow | Applied | ratio of | resistivity of |
| | Apparatus | | rate | current | hydrogen | processed water |
| | configuration | Condition | (L/h) | (A) | peroxide (%) | (MΩ · cm) |
| Example 1-2 | FIG. 2 | Condition 2 | 20 | 0.1 | 99 | 17.7 |
| Example 1-3 | FIG. 2 | Condition 3 | 20 | 0.1 | 100 | — |
| Comparative | FIG. 38 | Condition 2 | 20 | 0.1 | 17 | 17.9 |
| Example 1-3 | | | | | | |
| Comparative | FIG. 39 | Condition 2 | 20 | — | 58 | 0.6 |
| Example 1-4 | | | | | | |
| Comparative | FIG. 38 | Condition 3 | 20 | 0.1 | 0 | — |
| Example 1-5 | | | | | | |
| Comparative | FIG. 39 | Condition 3 | 20 | — | 44 | — |
| Example 1-6 | | | | | | |
| Example 1-4 | FIG. 2 | Condition 4 | 20 | 1 | 100 | — |
| Example 1-5 | FIG. 2 | Condition 5 | 20 | 1 | 100 | 17.7 |
| Comparative | FIG. 38 | Condition 4 | 20 | 1 | 66 | — |
| Example 1-7 | | | | | | |
| Comparative | FIG. 39 | Condition 4 | 20 | — | 59 | — |
| Example 1-8 | | | | | | |
| Comparative | FIG. 38 | Condition 5 | 20 | 1 | 24 | 17.9 |
| Example 1-9 | | | | | | |
| Comparative | FIG. 39 | Condition 5 | 20 | — | 60 | 0.6 |
| Example 1-10 | | | | | | |

<Influence of Flow Rate>

The flow rate of water to be processed was considered. As can be seen from Table 4, in Examples 1-5 and 1-6, the removal ratio of hydrogen peroxide was 100% even when the flow rate of water to be processed was changed. On the other hand, in the apparatus of the comparative examples, as can be seen by comparing the results of Comparative Examples 1-9 and 1-10 with those of Comparative Examples 1-11 and 1-12, even if the flow rate of the water to be processed was reduced by half, increasing the removal rate of hydrogen peroxide to nearly 100% as in the apparatus according to the present invention could not be achieved.

TABLE 4

| | | Water to be processed | | | Removal | Electrical |
|---|---|---|---|---|---|---|
| | | | Flow | Applied | ratio of | resistivity of |
| | Apparatus | | rate | current | hydrogen | processed water |
| | Configuration | Condition | (L/h) | (A) | peroxide (%) | (MΩ · cm) |
| Example 1-5 | FIG. 2 | Condition 5 | 20 | 1 | 100 | 17.7 |
| Example 1-6 | FIG. 2 | Condition 6 | 10 | 1 | 100 | 17.4 |
| Comparative | FIG. 38 | Condition 5 | 20 | 1 | 24 | 17.9 |
| Example 1-9 | | | | | | |
| Comparative | FIG. 39 | Condition 5 | 20 | — | 60 | 0.6 |
| Example 1-10 | | | | | | |
| Comparative | FIG. 38 | Condition 6 | 10 | 1 | 32 | 17.6 |
| Example 1-11 | | | | | | |
| Comparative | FIG. 39 | Condition 6 | 10 | — | 80 | 0.7 |
| Example 1-12 | | | | | | |

<Influence of Sodium in Water to be Processed>

A case in which sodium, a cationic component, is added to water to be processed was considered. Note that, by adding an aqueous NaOH solution, sodium was added to the water to be processed. As shown in Table 5, in Examples 1-7 and 1-8, even if sodium was contained in the water to be processed, the removal ratio of hydrogen peroxide was almost 100%. Further, in Example 1-8, even if sodium was contained in the water to be processed, a water quality as high as 15.1 MΩ·cm was obtained. On the other hand, in Comparative Examples 1-13, 1-14 and 1-15, the removal ratio of hydrogen peroxide was low.

TABLE 5

| | | Water to be processed | | | Removal | Electrical |
|---|---|---|---|---|---|---|
| | | | Flow | Applied | ratio of | resistivity of |
| | Apparatus | | rate | current | hydrogen | processed water |
| | Configuration | Condition | (L/h) | (A) | peroxide (%) | (MΩ · cm) |
| Example 1-7 | FIG. 2 | Condition 7 | 20 | 0.1 | 99 | 1.7 |
| Example 1-8 | FIG. 10 | Condition 7 | 20 | 0.1 | 100 | 15.1 |
| Comparative | FIG. 38 | Condition 7 | 20 | 0.1 | 13 | 1.7 |
| Example 1-13 | | | | | | |
| Comparative | FIG. 39 | Condition 7 | 20 | — | 64 | 0.7 |
| Example 1-14 | | | | | | |
| Comparative | FIG. 40 | Condition 7 | 20 | 0.1 | 14 | 15.4 |
| Example 1-15 | | | | | | |

From the results shown in Table 2 to Table 5 described above, it can be seen that, by means of the hydrogen peroxide removing apparatus and the hydrogen peroxide removing method according to the present invention, an electrical resistivity of the processed water of 1 MΩ·cm or more can be achieved and a removal ratio of hydrogen peroxide of 90% or more can be achieved.

### Example 2

The hydrogen peroxide removing apparatus shown in FIGS. 15 and 16 was assembled such that a plurality of hydrogen peroxide removal chambers 23 were located between anode 11 and cathode 12. Frame bodies each having a square opening of 10 cm×10 cm and a thickness of 1 cm were prepared, and two pieces of the frame bodies were superposed and filled with a regenerated Pd-supported anion exchange resin (Pd AER) in a regenerated from, thereby constituting hydrogen peroxide removal chamber 23 having a thickness of 2 cm. Hydrogen peroxide removal chamber 23 is partitioned on the side facing anode 11 by anion exchange membrane 32, and on the side facing cathode 12 thereof is partitioned by a superposition in which anion exchange membrane 81 and cation exchange membrane 33 are superposed on each other so that cation exchange membrane 33 is on the side of cathode 12. For each of the electrode chambers (anode chamber 21 and cathode chamber 25) and concentration chambers 22, 24, the same frame body was used to fill the ion exchanger so that the thickness was 1 cm. For the electrode chambers, concentration chambers 22, 24 and hydrogen peroxide removal chamber 23, water having a conductivity of 1.3 μS/cm, a hydrogen peroxide concentration of 97.5 μg/L, and a total carbonic acid concentration of 0.103 mg/L (as CO₂) was supplied, and a DC voltage was applied between anode 11 and cathode 12 so that the current became 1.04 A. The flow rate of the water to be processed to hydrogen peroxide removal chamber 23 was set to 88 L/h.

The hydrogen peroxide concentration contained in the processed water discharged from hydrogen peroxide removal chamber 23 when the system was stabilized after about 1000 hours have elapsed since passing water and application of the DC voltage to the hydrogen peroxide removing apparatus was started was determined, and the removal ratio of hydrogen peroxide in this hydrogen peroxide removing apparatus was determined. At the same time, the electrical resistivity of the water to be processed and the value of the DC voltage applied at that time were determined. Based on the applied voltage and the current value, the power consumption per unit flow rate of the water to be processed was determined. The results are shown in Table 6. Further, after completing these measurements, the Pd-supported anion exchange resin (Pd AER) was taken out from hydrogen peroxide removal chamber 23 to determine its volume in a free state, which was 95 to 100% of the volume of hydrogen peroxide removal chamber 23.

### Example 3

A hydrogen peroxide removing apparatus similar to that in Example 2 was assembled in which hydrogen peroxide removal chamber 23 and concentration chamber 24 located on the cathode 12 side thereof were partitioned only by cation exchange membrane 33. The hydrogen peroxide removing apparatus of Example 3 has the structure shown in FIG. 2. FIG. 41 shows the main part of the hydrogen peroxide removing apparatus of Example 3. In the hydrogen peroxide removing apparatus of Example 3, by using only one frame body used in Example 2, the thickness of hydrogen peroxide removal chamber 23 was 1 cm.

The same water as in Example 2 was used, and the same measurements as in Example 2 were carried out so that the flow rate of the water to be processed into hydrogen peroxide removal chamber 23 was set at 56 L/h and the current flowing between anode 11 and cathode 12 became 0.66 A. The results are shown in Table 6. Further, after completion of the measurements, the Pd-supported anion exchange resin (Pd AER) was taken out from hydrogen peroxide removal chamber 23 to determine its volume in a free state, which was 95 to 100% of the volume of hydrogen peroxide removal chamber 23. Note that, in the hydrogen peroxide removing apparatus of Example 3, a dissociation reaction of water proceeds at an interface between the Pd-supported anion exchange resin (Pd AER) and cation exchange membrane 33, but hydrogen ions generated at this time are released into concentration chamber 24 adjacent to hydrogen peroxide removal chamber 23 and react with the carbonic acid component contained in the water in concentration chamber 24 to generate free carbonic acid. Since the free carbonic acid does not have a charge, it is not affected by the charge repulsion of cation exchange membrane 33 and diffuses from concentration chamber 24 into hydrogen peroxide removal chamber 23 via cation exchange membrane 33. Since this free carbonic acid is not in an ionic form, it is hardly adsorbed to the Pd-supported anion exchange resin (Pd AER) in hydrogen peroxide removal chamber 23, and it is caused to leak to the processed water side and reduce the water quality. In order for the carbonic acid component to be adsorbed on the Pd-supported anion exchange resin (Pd AER), it needs to be converted into carbonate ions or bicarbonate ions. On the other hand, in the hydrogen peroxide removing apparatus of Example 2, since anion exchange membrane 81 is superposed on cation exchange membrane 33 in which the free carbonic acid diffuses, the free carbonic acid is reliably converted into carbonate ions or bicarbonate ions when passing through anion exchange membrane 81 and then released into hydrogen peroxide removal chamber 23, so that water quality deterioration in the processed water hardly occurs.

### Example 4

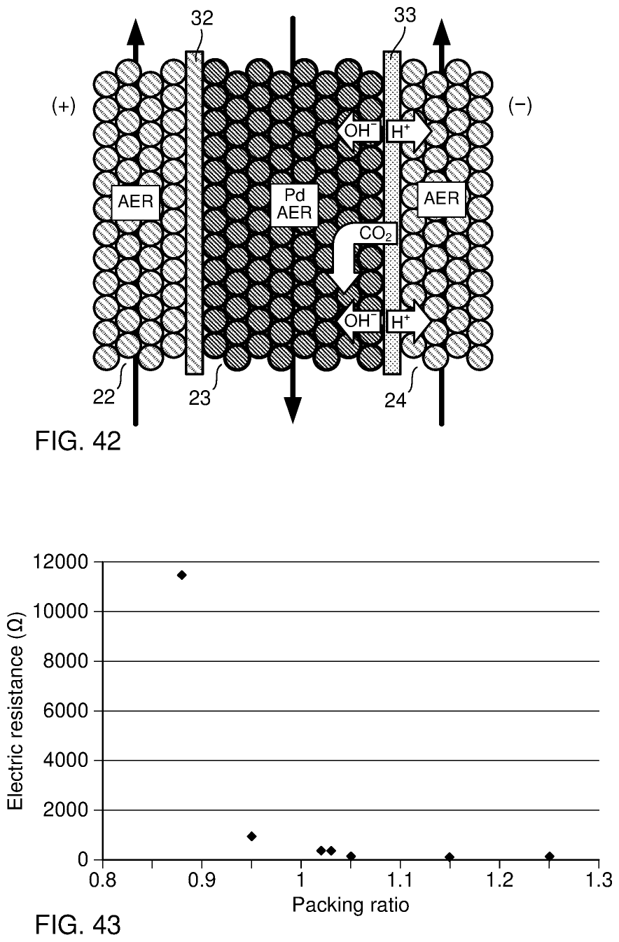

A hydrogen peroxide removing apparatus similar to that in Example 2 was assembled in which hydrogen peroxide removal chamber 23 and concentration chamber 24 located on the cathode 12 side thereof were partitioned only by cation exchange membrane 33. FIG. 42 shows the main part of the hydrogen peroxide removing apparatus of Example 4. In the hydrogen peroxide removing apparatus of Example 4, the thickness of hydrogen peroxide removal chamber 23 was 2 cm as in Example 2. The hydrogen peroxide removing apparatus of Example 4 also has the structure shown in FIG. 2, and Example 3 and Example 4 differ only in the thickness of hydrogen peroxide removal chamber 23.

The same water as in Example 2 was used, and the same measurements as in Example 2 were carried out so that the flow rate of the water to be processed into hydrogen peroxide removal chamber 23 was 88 L/h and the current flowing between anode 11 and cathode 12 became 1.04 A. The results are shown in Table 6. Further, after completion of the measurements, the Pd-supported anion exchange resin (Pd AER) was taken out from hydrogen peroxide removal chamber 23 to determine its volume in a free state, which was 95 to 100% of the volume of hydrogen peroxide removal chamber 23. Note that, even in the hydrogen peroxide removing apparatus of Example 4, a dissociation reaction of water proceeds at an interface between the Pd-supported anion exchange resin (Pd AER) and cation exchange membrane 33, but hydrogen ions generated at this time diffuse into concentration chamber 24 via cation exchange membrane 33 to generate free carbonic acid.

TABLE 6

| | | | | Power |
|---|---|---|---|---|
| | | Electrical | | consumption |
| | Removal ratio | resistivity | | per amount |
| | of hydrogen | of processed | Applied | of processed |
| | peroxide | water | voltage | water |
| | [%] | [MΩ · cm] | [V] | [W · h/L] |
| Example 2 | >98 | 16.0 | 10.0 | 0.11 |
| Example 3 | >98 | 12.9 | 14.6 | 0.17 |
| Example 4 | >98 | 15.0 | 29.2 | 0.33 |

Comparing Examples 2 to 4, the hydrogen peroxide removal ratio is substantially the same, and the electrical resistivity of the processed water is highest in Example 2. With regard to any of Examples 2 to 4, the DC voltage applied between anode 11 and cathode 12 was within a practicable range. However, while the applied voltage in Example 2 was 10.0 V, the applied voltage in Example 3 was about 1.5 times that of Example 1 at 14.6 V despite the current value was reduced than in Example 2. In Example 4, which had the same current value as in Example 2, the applied voltage was 29.2 V, which was about 3 times. With the applied voltage increased, in the power consumption per unit flow rate of the processed water, compared to a value of 0.11 Wh/L in Example 2, the value in Example 3 was 0.17 Wh/L which was about 1.5 times that of Example 2, and the value in Example 4 was 0.33 Wh/L which was about 3 times that of Example 2. The reason why the applied voltage can be lowered in Example 2 and the power consumption per amount of the processed water can be reduced in this way is considered to be that, in Example 2, a dissociation reaction of water occurs on the entire surface of the bonding interface between anion exchange membrane 81 and cation exchange membrane 33, so that a large amount of hydroxide ions used for electric regeneration of the ion exchanger is supplied to hydrogen peroxide removal chamber 23. On the other hand, in Examples 3 and 4, since the dissociation reaction of water proceeds only in a relatively narrow place in which the Pd-supported anion exchange resin (Pd AER) and cation exchange membrane 33 come into contact with each other, it can be considered that an increase in the applied voltage is caused. Further, it is considered that the reason why the electrical resistivity of the processed water is high in Example 2 is that the free carbonic acid diffusing from concentration chamber 24 into hydrogen peroxide removal chamber 23 is converted into carbonate ions or bicarbonate ions when diffusing through anion exchange membrane 81, and then captured by the Pd-supported anion exchange resin (Pd AER).

### Example 5

The packing ratio of ion exchanger in the hydrogen peroxide removal chamber was considered. Here, as described above, the packing ratio of the ion exchanger is a value obtained by dividing the volume in the free state of the ion exchanger taken out from the hydrogen peroxide removal chamber after applying a DC voltage between the anode and the cathode and then passing the water to be processed through the hydrogen peroxide removal chamber by the volume of the hydrogen peroxide removal chamber. A hydrogen peroxide removing apparatus having the same configuration as in Example 2 was used, and hydrogen peroxide removal chamber 23 was filled with a salt-form Pd-supported anion-exchange resin (Pd AER). By changing the filling amount, the hydrogen peroxide removing apparatuses of Example 5-1 and Example 5-2 were assembled. For the electrode chambers, concentration chambers 22, 24 and hydrogen peroxide removal chamber 23, water having a conductivity of 1.3 μS/cm, a hydrogen peroxide concentration of 97.5 μg/L, and a total carbonic acid concentration of 0.103 mg/L (as CO₂) was supplied, and a voltage was applied between anode 11 and cathode 12 so that the current became 1.04 A. The flow rate of the water to be processed to hydrogen peroxide removal chamber 23 was set to 88 L/h.

For each of the hydrogen peroxide removing apparatuses of Example 5-1 and Example 5-2, the hydrogen peroxide concentration contained in the processed water discharged from hydrogen peroxide removal chamber 23 was determined when the system became stable after about 500 hours elapsed since passing water and application of a DC voltage to the hydrogen peroxide removing apparatus was started, and the hydrogen peroxide removal ratio in this hydrogen peroxide removing apparatus was determined. At the same time, the electrical resistivity of the processed water and the value of the DC voltage applied at that time were determined. The results are shown in Table 7. Further, after completing these measurements, the Pd-supported anion exchange resin (Pd AER) was taken out from hydrogen peroxide removal chamber 23 to obtain its volume in a free state, and the packing ratio was determined. The packing ratio was 110 to 115% in Example 5-1, and 95 to 100% in Example 5-2.

TABLE 7

| | | | | | Power |
|---|---|---|---|---|---|
| | | Removal | Electrical | | consumption |
| | | ratio of | resistivity | | per amount |
| | Packing | hydrogen | of processed | Applied | of processed |
| | ratio | peroxide | water | voltage | water |
| | [%] | [%] | [MΩ · cm] | [V] | [W · h/L] |
| Example 5-1 | 110-115 | 100 | 16.9 | 6.5 | 0.07 |
| Example 5-2 | 95-115 | 98 | 15.0 | 29.2 | 0.33 |

Comparing Example 5-1 and Example 5-2, the hydrogen peroxide removal ratio is substantially the same, and there is a slight difference in the electrical resistivity of the processed water. However, while the applied voltage is 6.5V in Example 5-1 having a high packing ratio, the applied voltage is 29.2V in Example 5-2 having a low packing ratio, which is about 4.5 times as large as that in Example 5-1. Compared to Example 2, it was possible to lower the applied voltage in Example 5-1 with a higher packing ratio. It was found that the applied voltage can be lowered by increasing the packing ratio within a range that does not interfere with the water flow of the water to be processed. Further, since the voltage is lowered and electric current flows easily, it is considered that the electrical resistivity of the processed water of Example 5-1 became slightly higher and had a good value.

### Example 6

The relationship between the packing ratio of the ion exchanger on which the platinum group metal catalyst was supported and the electric resistance of the hydrogen peroxide removal chamber was investigated. Here, a space of a 53.1 cm³ provided with a plate electrode of platinum on each of both sides was prepared to simulate a hydrogen peroxide removal chamber, and a salt-form Pd-supported anion exchange resin was filled in this space so as to correspond to a packing ratio, and ultrapure water having a temperature of 25° C. was passed through. Then, an AC voltage having a frequency of 1 kHz and a voltage of 1000 mV was applied between the plate electrodes using an LCR meter to measure the impedance between the plate electrodes, which was then evaluated as an electrical resistance at the time of applying a DC voltage when operating as a hydrogen peroxide removing apparatus. The results are shown in FIG. 43. As shown in FIG. 43, when the packing ratio is less than 0.95 (i.e., 95%), electrical resistance is significantly increased, and the electrical regeneration of the ion exchanger in hydrogen peroxide removal chamber 23 required a lot of energy. It was found that the packing ratio is preferably 0.95 or more and 1.25 or less, and more preferably 1.02 or more and 1.25 or less.

### Example 7

Similarly to Example 5, the packing ratio of the ion exchanger in the hydrogen peroxide removal chamber was investigated. A hydrogen peroxide removing apparatus having the same configuration as in Example 4, which is shown in FIG. 42, was used, and hydrogen peroxide removal chamber 23 was filled with a salt-form Pd-supported anion-exchange resin (Pd AER). By changing the filling amount, the hydrogen peroxide removing apparatuses of Example 7-1 and Example 7-2 were assembled. For the electrode chambers, concentration chambers 22, 24 and hydrogen peroxide removal chamber 23, water having a conductivity of 1.2 μS/cm, a hydrogen peroxide concentration of 102 μg/L, and a total carbonic acid concentration of 0.104 mg/L (as CO₂) was supplied in Example 7-1, and water having a conductivity of 1.3 μS/cm, a hydrogen peroxide concentration of 96.3 μg/L, and a total carbonic acid concentration of 0.103 mg/L (as CO₂) was supplied in Example 7-2. In both of Examples 7-1 and 7-2, the flow rate of the water to be processed to hydrogen peroxide removal chamber 23 was set to 88 L/h, and a voltage was applied between anode 11 and cathode 12 so that the current became 1.04 A.

For each of the hydrogen peroxide removing apparatuses of Example 7-1 and Example 7-2, the hydrogen peroxide concentration contained in the processed water discharged from hydrogen peroxide removal chamber 23 was determined when the system was stabilized after about 300 hours elapsed since passing water and application of a DC voltage to the hydrogen peroxide removing apparatus was started, and the hydrogen peroxide removal ratio in this hydrogen peroxide removing apparatus was determined. At the same time, the electrical resistivity of the processed water, the value of the DC voltage applied at that time, and the power consumption per amount of the processed water were determined. The results are shown in Table 8. Further, after completing these measurements, the Pd-supported anion exchange resin (Pd AER) was taken out from hydrogen peroxide removal chamber 23 to obtain its volume in a free state, and the result was found to be 110 to 115% in Example 7-1, and 95 to 100% in Example 7-2.

TABLE 8

| | | | | | Power |
|---|---|---|---|---|---|
| | | Removal | Electrical | | consumption |
| | | ratio of | resistivity | | per amount |
| | Packing | hydrogen | of processed | Applied | of processed |
| | ratio | peroxide | water | voltage | water |
| | [%] | [%] | [MΩ · cm] | [V] | [W · h/L] |
| Example 7-1 | 110-115 | 100 | 17.1 | 8.1 | 0.09 |
| Example 7-2 | 95-100 | 99.4 | 11.1 | 21.5 | 0.25 |

Comparing Example 7-1 and Example 7-2, the hydrogen peroxide removal ratio is substantially the same, and there is a difference in the electrical resistivity of the processed water. In Example 7-1 with the high packing ratio, the applied voltage becomes less than half of that of Example 7-2, and accordingly, the power consumption became low. Since the voltage is lowered and electric current flows easily, it is considered that the electrical resistivity of the processed water of Example 7-1 became higher than the case of Example 7-2 and had a good value.

### REFERENCE SIGNS LIST

11 Anode;
12 Cathode;
21, 26 Anode chamber;
22, 24 Concentration chamber;
23, 29 Hydrogen peroxide removal chamber;
25, 27 Cathode chamber;
28 Deionization chamber;
31, 33, 35, 83 Cation exchange membrane (CEM);
32, 34, 37, 38, 81, 82 Anion exchange membrane (AEM);
36 Intermediate ion exchange membrane;
51, 52 Reverse osmosis membrane device;
54 Electrodeionization device (EDI);
55, 61 Ultraviolet oxidization device (UV);
56, 63 Non-regenerative ion exchange resin (CP);
57 Boron-selective ion exchange resin (B IER);
58, 65 Degassing membrane (MD);
67 Ultrafiltration membrane (UF);
100 Hydrogen peroxide removing apparatus;
300 Pure water producing apparatus; and
400 Ultrapure water producing apparatus.

1. A method for removing hydrogen peroxide contained in water to be processed, comprising:
passing the water to be processed through a hydrogen peroxide removal chamber which is provided between an anode and a cathode and in which a metal catalyst with hydrogen peroxide decomposition ability is at least partially filled, while applying a DC voltage between the anode and the cathode.

2. The method according to claim 1, wherein the hydrogen peroxide removal chamber is filled with an ion exchanger, and the metal catalyst is supported on at least a portion of the ion exchanger.

3. The method according to claim 2, wherein the ion exchanger is an anion exchanger.

4. The method according to claim 2, wherein a packing ratio, which is a value obtained by dividing a volume in a free state of the ion exchanger taken out from the hydrogen peroxide removal chamber after the passing of the water by a volume of the hydrogen peroxide removal chamber, is 95% or more and 125% or less.

5. The method according to claim 1, wherein the metal catalyst is a platinum group metal catalyst.

6. The method according to claim 1, wherein the hydrogen peroxide removal chamber is partitioned by an anion exchange membrane on a side facing the anode and is partitioned by a cation exchange membrane on a side facing the cathode.

7. The method according to claim 1, wherein a concentration of hydrogen peroxide in the water to be processed is 1 μg/L or more.

8. The method according to claim 1, wherein the water to be processed contains a carbonic acid component.

9. The method according to claim 8, wherein a concentration of the carbonic acid component in the water to be processed is 0.01 mg/L as CO₂ or more in total carbonic acid.

10. A hydrogen peroxide removing apparatus for removing hydrogen peroxide contained in water to be processed, comprising:
an anode and a cathode; and
a hydrogen peroxide removal chamber provided between the anode and the cathode and at least partially filled with a metal catalyst with hydrogen peroxide decomposition ability,
wherein a DC voltage is applied between the anode and the cathode.

11. The hydrogen peroxide removing apparatus according to claim 10, wherein a first ion exchanger is filled in the hydrogen peroxide removal chamber, and the metal catalyst is supported on at least a portion of the first ion exchanger.

12. The hydrogen peroxide removing apparatus according to claim 11, wherein the first ion exchanger is an anion exchanger.

13. The hydrogen peroxide removing apparatus according to claim 11, wherein a packing ratio, which is a value obtained by dividing, by a volume of the hydrogen peroxide removal chamber, a volume in a free state of the ion exchanger taken out from the hydrogen peroxide removal chamber after applying the DC voltage between the anode and the cathode and passing the water to be processed through the hydrogen peroxide removal chamber, is 95% or more and 125% or less.

14. The hydrogen peroxide removing apparatus according to claim 10, wherein the metal catalyst is a platinum group metal catalyst.

15. The hydrogen peroxide removing apparatus according to claim 11, wherein the hydrogen peroxide removal chamber is partitioned by a first ion exchange membrane on a side facing the anode and is partitioned by a second ion exchange membrane on a side facing the cathode.

16. The hydrogen peroxide removing apparatus according to claim 15, wherein the first ion exchange membrane is an anion exchange membrane and the second ion exchange membrane is a cation exchange membrane.

17. The hydrogen peroxide removing apparatus according to claim 15, comprising:
a first concentration chamber disposed between the anode and the first ion exchange membrane; and
a second concentration chamber disposed between the cathode and the second ion exchange membrane.

18. The hydrogen peroxide removing apparatus according to claim 15,
wherein either one of the first ion exchange membrane and the second ion exchange membrane is an intermediate ion exchange membrane, and
wherein the hydrogen peroxide removing apparatus comprises a deionization chamber which is adjacent to the hydrogen peroxide removal chamber via the intermediate ion exchange membrane and is filled with a second ion exchanger.

19. A pure water producing apparatus comprising:
the hydrogen peroxide removing apparatus according to claim 10; and
an ultraviolet oxidation device provided at a preceding stage of the hydrogen peroxide removing apparatus.
